(19) United States
(12) Patent Application Publication
(10) Pub. No.: US 2021/0286232 A1
(43) Pub. Date: Sep. 16, 2021

(54) OPTICAL DEVICE AND IMAGING DEVICE

(71) Applicant: SONY CORPORATION, TOKYO (JP)

(72) Inventors: YUSUKE SUGITA, TOKYO (JP); TAKEO KISHIDA, CHIBA (JP); SHIGEKI FUJIBAYASHI, TOKYO (JP)

(21) Appl. No.: 16/328,331

(22) PCT Filed: Jul. 28, 2017
(86) PCT No.: PCT/JP2017/027533

§ 371 Date: Feb. 26, 2019

(30) Foreign Application Priority Data
Sep. 27, 2016 (JP) 2016-187952

(51) Int. Cl. G03B 5/00; G02B 27/64

(52) U.S. Cl. CPC G03B 5/00; G03B 2205/0053; G02B 27/646

(57) ABSTRACT

To secure smooth operation states of a movable body and achieve improvement in functionality.

An optical device includes: a movable body including an optical element; a support body configured to support the movable body; at least one first spherical body configured to be positioned between the movable body and the support body in an axial direction of a first fulcrum axis orthogonal to an optical axis and to be rollable; and at least one second spherical body configured to be positioned between the movable body and the support body in an axial direction of a second fulcrum axis orthogonal to the optical axis and the first fulcrum axis and to be rollable. The movable body is supported by the support body via the first spherical body and the second spherical body, and the movable body is movable in an optical axis direction and is pivotable in a first pivoting direction with the first fulcrum axis as a fulcrum and a second pivoting direction with the second fulcrum axis as a fulcrum with respect to the support body.

### TECHNICAL FIELD

The present technology relates to the technical field of an optical device that includes a movable body having an optical element and a support body that supports the movable body and causes the movable body to operate with respect to the support body in a predetermined direction, and an imaging device that includes the optical device.

### BACKGROUND ART

There are imaging devices such as video cameras and still cameras with optical devices that correct camera shake by causing a lens or an image sensor that is an optical element to operate in a direction orthogonal to an optical axis direction or a pivoting direction having an axis orthogonal to the optical axis direction as a fulcrum, or the like.

Among such imaging devices, for example, there is one with a movable body having an optical element which is designed to be movable in a first direction orthogonal to an optical axis direction and a second direction orthogonal to both the optical axis direction and the first direction (e.g., refer to Patent Literature 1).

In addition, among the above-described imaging devices, for example, there is one with a movable body having an optical element which is designed to be pivotable in a first pivoting direction (yawing direction) that is the direction around a first fulcrum axis orthogonal to an optical axis direction and a second pivoting direction (pitching direction) that is the direction around a second fulcrum axis orthogonal to both the optical axis and the first fulcrum axis (e.g., refer to Patent Literature 2).

Since the movable body is designed to be caused to operate in two different directions in the imaging devices disclosed in Patent Literature 1 and Patent Literature 2, correction of camera shake and improvement in the quality of photographed images are achieved.

### CITATION LIST

### Patent Literature

Patent Literature 1: JP 2011-13614A

Patent Literature 2: JP 2013-140285A

### DISCLOSURE OF INVENTION

### Technical Problem

However, although the imaging devices disclosed in Patent Literature 1 and Patent Literature 2 achieve correction of camera shake and improvement in image quality by moving the movable body in two different directions, camera shake may occur in various directions other than the left-right direction and the top-bottom direction.

Therefore, in order to further improve image quality, it is desirable to secure smooth operation states of a movable body and thereby achieve further improvement in functionality of an imaging device having an optical device.

In addition, it is desirable to also achieve improvement in other photographing-related functions, for example, functionality of a close-up function or the like, in addition to improvement in the camera shake correction function.

Therefore, an optical device and an imaging device of the present technology aim to overcome the above-described problems and to secure smooth operation states of a movable body and achieve improvement in functionality.

### Solution to Problem

Firstly, in order to achieve the above object, an optical device according to the present technology includes: a movable body including an optical element; a support body configured to support the movable body; at least one first spherical body configured to be positioned between the movable body and the support body in an axial direction of a first fulcrum axis orthogonal to an optical axis and to be rollable; and at least one second spherical body configured to be positioned between the movable body and the support body in an axial direction of a second fulcrum axis orthogonal to the optical axis and the first fulcrum axis and to be rollable. The movable body is supported by the support body via the first spherical body and the second spherical body, and the movable body is movable in an optical axis direction and is pivotable in a first pivoting direction with the first fulcrum axis as a fulcrum and a second pivoting direction with the second fulcrum axis as a fulcrum with respect to the support body.

Accordingly, the movable body is caused to operate in the optical axis direction, the first pivoting direction, and the second pivoting direction in the state in which the movable body is supported by the support body via the first spherical body and the second spherical body.

Secondly, in the optical device according to the present technology, a plurality of at least one of the first spherical bodies or the second spherical bodies is preferably provided.

Accordingly, rotation of the movable body with respect to the support body in a direction around the optical axis is regulated.

Thirdly, in the optical device according to the present technology, the movable body is preferably energized in a direction in which the movable body is pushed against the first spherical body in the axial direction of the first fulcrum axis.

Accordingly, the movable body is pushed against the first spherical body and the first spherical body is pushed against the support body, and thus rattling of the movable body with respect to the first spherical body in the axial direction of the first fulcrum axis does not occur.

Fourthly, in the optical device according to the present technology, the movable body is preferably energized in a direction in which the movable body is pushed against the second spherical body in the axial direction of the second fulcrum axis.

Accordingly, the movable body is pushed against the second spherical body and the second spherical body is pushed against the support body, and thus rattling of the movable body with respect to the first spherical body in the axial direction of the second fulcrum axis does not occur.

Fifthly, in the optical device according to the present technology, the movable body is preferably energized in at least one direction of a direction in which the movable body is pushed against the first spherical body in the axial direction of the first fulcrum axis or a direction in which the movable body is pushed against the second spherical body in the axial direction of the second fulcrum axis, a magnet is preferably disposed on one of the support body and the movable body and a magnetic plate is preferably disposed on the other of the support body and the movable body, and the magnetic plate is preferably attracted by the magnet and thus the movable body is preferably energized.

Accordingly, the magnetic plate disposed on the one of the support body and the movable body is attracted by the magnet disposed on the other, and thus the movable body is energized.

Sixthly, in the optical device according to the present technology, at least one of the first spherical body or the second spherical body is preferably positioned in a row with the magnet in the axial direction of the first fulcrum axis or the axial direction of the second fulcrum axis.

Accordingly, at least one of the first spherical body or the second spherical body and the magnet are disposed in a row in the direction orthogonal to the optical axis direction.

Seventhly, in the optical device according to the present technology, a spherical body support member configured to freely rollably support each of the first spherical body and the second spherical body is preferably provided, a disposition base on which the magnet is disposed is preferably provided, and the spherical body support member is preferably disposed on the disposition base.

Accordingly, the spherical body support members that support the first spherical body and the second spherical body are disposed on the disposition base on which the magnet is disposed.

Eighthly, in the optical device according to the present technology, the magnet is preferably provided in a movability drive part that causes the movable body to operate with respect to the support body.

Accordingly, the magnet of the movability drive part that causes the movable body to operate with respect to support body is used as a magnet that energizes the movable body.

Ninthly, in the optical device according to the present technology, two movability drive parts that are positioned to be separated to upper and lower sides or left and right sides and cause the movable body to operate with respect to the support body are preferably provided.

Accordingly, the movable body is moved in the optical axis direction and pivoted in the first pivoting direction and the second pivoting direction with respect to the support body by the two movability drive parts.

Tenthly, in the optical device according to the present technology, one magnet and one coil are preferably provided in one of the movability drive parts, and a plurality of magnets and a plurality of coils are preferably provided in the other of the movability drive parts.

Accordingly, the movable body is moved in the optical axis direction and pivoted in the first pivoting direction and the second pivoting direction with respect to the support body by the two movability drive parts including the movability drive part in which one magnet and one coil are provided.

Eleventhly, in the optical device according to the present technology, a frame part that is penetrated in the optical axis direction is preferably provided in the movable body, and the optical element is preferably held by the frame part.

Accordingly, the movable body has the frame part in a shape that realizes a combination of high rigidity and a light weight.

Twelfthly, in the optical device according to the present technology, a frame-shaped part that is penetrated in the optical axis direction is preferably provided in the support body.

Accordingly, the support body has the frame-shaped part that realizes a combination of high rigidity and a light weight.

Thirteenthly, in the optical device according to the present technology, the movable body is preferably positioned on an inner side of an inner circumference of the frame-shaped part.

Accordingly, the movable body is not positioned on the outer side of the inner circumference of the frame-shaped part.

Fourteenthly, in the optical device according to the present technology, an image sensor is preferably provided as the optical element.

Accordingly, the image sensor is moved in the optical axis direction due to movement of the movable body in the optical axis direction.

Fifteenthly, in the optical device according to the present technology, a fixed body that freely movably supports the support body is preferably provided, and the support body is preferably movable with respect to the fixed body in a first movement direction orthogonal to the optical axis and a second movement direction orthogonal to the optical axis direction and the first movement direction.

Accordingly, the movable body is movable with respect to the fixed body in the first movement direction and the second movement direction in addition to the optical axis direction, the first pivoting direction, and the second pivoting direction.

Sixteenthly, in the optical device according to the present technology, the support body is preferably pivotable with respect to the fixed body in a direction around the optical axis.

Accordingly, the movable body is movable in the direction around the optical axis with respect to the fixed body, in addition to the optical axis direction, the first pivoting direction, the second pivoting direction, the first movement direction, and the second movement direction.

Seventeenthly, in the optical device according to the present technology, three operation drive parts that cause the support body to operate with respect to the fixed body are preferably provided, two operation drive parts among the three operation drive parts are preferably disposed to be separated in the axial direction of the first fulcrum axis or the axial direction of the second fulcrum axis, and the operation drive part other than the two operation drive parts among the three operation drive parts is preferably disposed to be separated from the two operation drive parts in a direction orthogonal to a direction in which the two operation drive parts are connected.

Accordingly, the support body is caused operate with respect to the fixed body in the first movement direction, the second movement direction, and the direction around the optical axis by the three operation drive parts.

Eighteenthly, in the optical device according to the present technology, a first operation drive part and a second operation drive part are preferably provided as the two operation drive parts, a third operation drive part is preferably provided as the operation drive part other than the two operation drive parts, a fourth operation drive part is preferably provided as an operation drive part that causes the support body to operate with respect to the fixed body, and the fourth operation drive part is preferably disposed to be separated from the third operation drive part in a direction in which the first operation drive part and the second operation drive part are connected.

Accordingly, the first operation drive part and the second operation drive part are disposed to be separated in the axial direction of the first fulcrum axis or the axial direction of the second fulcrum axis and the third operation drive part and the fourth operation drive part are disposed to be separated in the same direction as the separation direction of the first operation drive part and the second operation drive part.

Ninteenthly, in the optical device according to the present technology, the support body is preferably positioned on an inner side of an outer circumference of the fixed body.

Accordingly, the movable body is not positioned on the outer side of the outer circumference of the fixed body.

Twentiethly, in order to achieve the above object, an imaging device according to the present technology includes an optical device that causes an optical element to operate. An imaging operation is performed by converting an optical image that has been taken in via an optical system into an electrical signal. The optical device includes a movable body including the optical element, a support body configured to support the movable body, at least one first spherical body configured to be positioned between the movable body and the support body in an axial direction of a first fulcrum axis orthogonal to an optical axis and to be rollable, and at least one second spherical body configured to be positioned between the movable body and the support body in an axial direction of a second fulcrum axis orthogonal to the optical axis and the first fulcrum axis and to be rollable. The movable body is supported by the support body via the first spherical body and the second spherical body. The movable body is movable in an optical axis direction and is pivotable in a first pivoting direction with the first fulcrum axis as a fulcrum and a second pivoting direction with the second fulcrum axis as a fulcrum with respect to the support body.

Accordingly, in the optical device, the movable body is caused to operate in the optical axis direction, the first pivoting direction, and the second pivoting direction in the state in which the movable body is supported by the support body via the first spherical body and the second spherical body.

### Advantageous Effects of Invention

According to the present technology, since the movable body is caused to operate in the optical axis direction, the first pivoting direction, and the second pivoting direction in the state in which the movable body is supported by the support body via the first spherical body and the second spherical body, improvement in functionality can be achieved.

Note that the effects described here are not necessarily limiting, and any effect disclosed in the present disclosure may be included.

### BRIEF DESCRIPTION OF DRAWINGS

FIG. 1 is an exploded perspective view of an imaging device for illustrating an embodiment of an optical device and an imaging device of the present technology together with FIG. 2 to FIG. 48.

FIG. 2 is an exploded perspective view of the optical device.

FIG. 3 is a perspective view of the optical device.

FIG. 4 is a front view of the optical device.

FIG. 5 is a perspective view of a support body.

FIG. 6 is an exploded perspective view of a movable body.

FIG. 7 is a perspective view illustrating a state in which the support body is supported by a fixed body.

FIG. 8 is a perspective view illustrating a state in which the movable body is supported by the support body.

FIG. 9 is a front view illustrating a state in which the support body has been moved with respect to the fixed body in an X direction, for illustrating an operation of the optical device together with FIG. 10 to FIG. 14.

FIG. 10 is a front view illustrating a state in which the support body has been moved with respect to the fixed body in a Y direction.

FIG. 11 is a front view illustrating a state in which the support body has been pivoted with respect to the fixed body in the rolling direction.

FIG. 12 is a plan view illustrating a state in which the movable body has been pivoted with respect to the support body in the yawing direction.

FIG. 13 is a side view illustrating a state in which the movable body has been pivoted with respect to the support body in the pitching direction.

FIG. 14 is a plan view illustrating a state in which the movable body has been moved with respect to the support body in the optical axis direction.

FIG. 15 is a perspective view illustrating an example of a movement regulation part.

FIG. 16 is a front view illustrating a first disposition example, and illustrates a disposition example of four operation drive parts together with FIG. 17 to FIG. 22.

FIG. 17 is a front view illustrating a second disposition example.

FIG. 18 is a front view illustrating a third disposition example.

FIG. 19 is a front view illustrating a fourth disposition example.

FIG. 20 is a front view illustrating a fifth disposition example.

FIG. 21 is a front view illustrating a sixth disposition example.

FIG. 22 is a front view illustrating a seventh disposition example.

FIG. 23 is a front view illustrating a first disposition example, and illustrates a disposition example of three operation drive parts together with FIG. 24 to FIG. 30.

FIG. 24 is a front view illustrating a second disposition example.

FIG. 25 is a front view illustrating a third disposition example.

FIG. 26 is a front view illustrating a fourth disposition example.

FIG. 27 is a front view illustrating a fifth disposition example.

FIG. 28 is a front view illustrating a sixth disposition example.

FIG. 29 is a front view illustrating a seventh disposition example.

FIG. 30 is a front view illustrating an eighth disposition example.

FIG. 31 is a perspective view illustrating the first disposition example, and illustrates a disposition example of a movability drive part having four drive parts together with FIG. 32 to FIG. 35.

FIG. 32 is a perspective view illustrating a second disposition example

FIG. 33 is a perspective view illustrating a third disposition example.

FIG. 34 is a perspective view illustrating a fourth disposition example.

FIG. 35 is a perspective view illustrating a fifth disposition example.

FIG. 36 is a perspective view illustrating a first disposition example, and illustrates a disposition example of a movability drive part having three drive parts together with FIG. 37 to FIG. 47.

FIG. 37 is a perspective view illustrating a second disposition example

FIG. 38 is a perspective view illustrating a third disposition example.

FIG. 39 is a perspective view illustrating a fourth disposition example.

FIG. 40 is a perspective view illustrating a fifth disposition example.

FIG. 41 is a perspective view illustrating a sixth disposition example.

FIG. 42 is a perspective view illustrating a seventh disposition example.

FIG. 43 is a perspective view illustrating an eighth disposition example.

FIG. 44 is a perspective view illustrating a ninth disposition example.

FIG. 45 is a perspective view illustrating a tenth disposition example.

FIG. 46 is a perspective view illustrating an eleventh disposition example.

FIG. 47 is a perspective view illustrating a twelfth disposition example.

FIG. 48 is a block diagram of an imaging device.

### MODE(S) FOR CARRYING OUT THE INVENTION

Embodiments for implementing an optical device and an imaging device of the present technology will be described below with reference to the drawings.

The embodiments which will be introduced below are an application of an imaging device of the present technology to a still camera and an application of an optical device of the present technology to an optical device provided in the still camera.

Note that the ranges of applications of an imaging device and applications of an optical device of the present technology are not limited to a still camera or an optical device provided in the still camera. An imaging device and an optical device of the present technology can be widely applied, for example, not only to video cameras but also to imaging devices incorporated into various apparatuses such as mobile terminals like mobile telephones or optical devices provided in the imaging devices.

In addition, an optical device of the present technology can also be applied to an optical device provided in an imaging device and, for example, another optical device such as a microscope or binoculars.

In the following description, front-rear, top-bottom, and left-right directions are assumed to be determined on the basis of a direction from an image plane side at the time of photographing of a still camera. Thus, an object side (a subject side) will be front and an image plane side (a photographer side) will be rear.

Note that the top-bottom, front-rear, and left-right directions which will be described below are for the sake of convenience, and embodiments of the present technology are not limited to the directions.

In addition, a lens which will be described below can be either of a lens part including a single lens and a lens part including a lens group including a plurality of lenses.

### <Overall Configuration of Imaging Device>

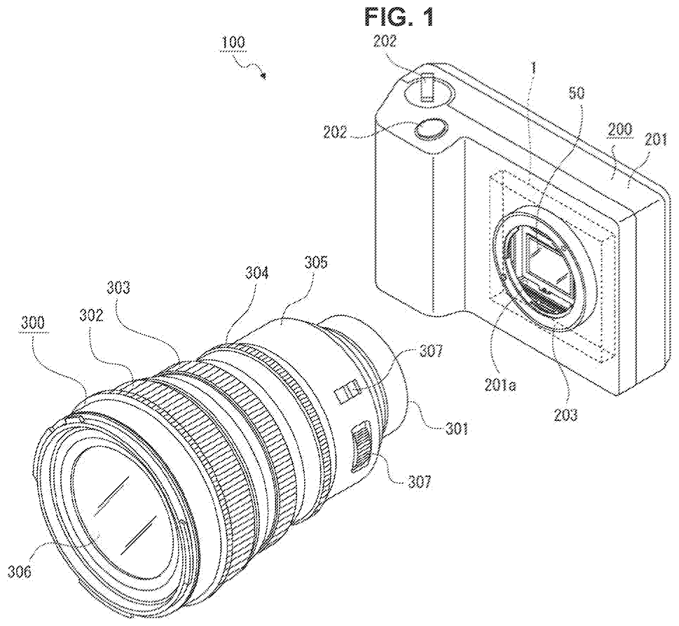

An imaging device 100 includes a device main body 200 and an interchangeable lens 300 (see FIG. 1). Note that the present technology can be applied to a type in which a lens barrel having a structure similar to the internal structure of the interchangeable lens 300 is incorporated into a device main body and a retractable type in which a lens barrel projects from or is housed in a device main body.

The device main body 200 is formed with each of necessary parts disposed inside and outside of an outer housing 201.

For example, various operation parts 202, 202, . . . are disposed on the top surface and the rear surface of the outer housing 201. As the operation parts 202, 202, . . . , for example, a power button, a shutter button, a zoom knob, a mode switch knob, and the like are provided.

A display (display part), which is not illustrated, is disposed on the rear surface of the outer housing 201.

A circular opening 201a is formed on the front surface of the outer housing 201, and the surrounding part of the opening 201a is provided as a mount part 203 for allowing the interchangeable lens 300 to be attached thereto.

A lens mount 301 that is, for example, bayonet-connected to the mount part 203 of the device main body 200 is provided at a rear end part of the interchangeable lens 300. A first operation ring 302 that functions as a focus ring, a second operation ring 303 that functions as a zoom ring, and a third operation ring 304 that functions as an iris ring are provided on the interchangeable lens 300. Manual focusing is performed by rotating the first operation ring 302, manual zooming is performed by rotating the second operation ring 303, iris blades, which are not illustrated, are caused to operate by rotating the third operation ring 304, and thereby an amount of light taken into the interchangeable lens 300 is adjusted.

The interchangeable lens 300 has a photographing lens 306 disposed at the front-most side of a housing 305 formed in a substantially cylindrical shape.

A plurality of operation knobs 307, 307, . . . is disposed apart from each other in the circumferential direction of the housing 305 at positions near the rear end thereof. As the operation knobs 307, 307, . . . , for example, a power zoom knob for performing zooming driven by a motor, a state switching knob for switching between a manual state and an automatic state, and the like are provided. By operating the mode switching knob, for example, focusing and zooming of the first operation ring 301 and the second operation ring 302 can be performed through manual rotation.

Optical elements such as a lens group, iris blades, and the like, which are not illustrated, are disposed inside the housing 305.

### <Configuration of Optical Device>

An optical device 1 is disposed inside the outer housing 201 of the device main body 200 (see FIG. 1).

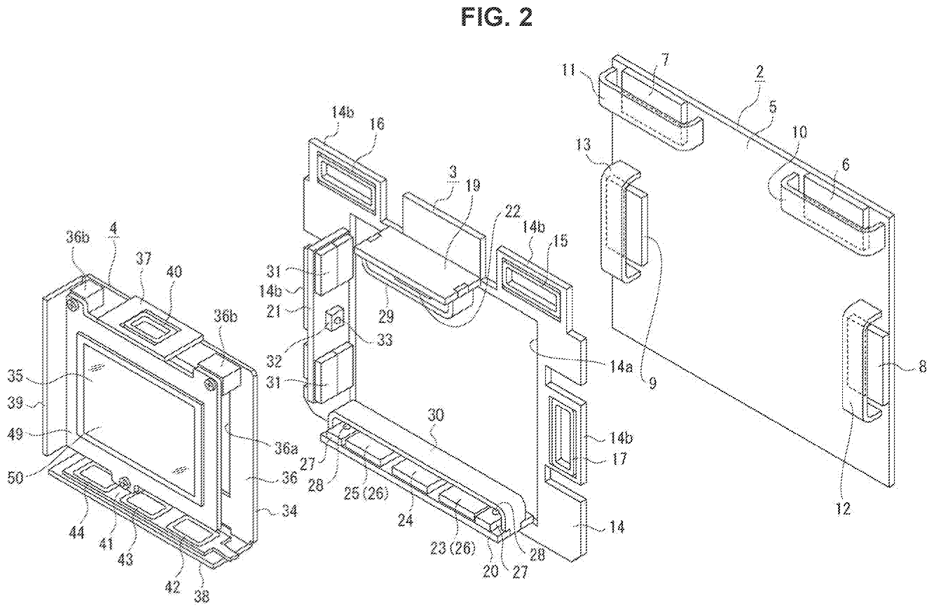

The optical device 1 includes a fixed body 2, a support body 3, and a movable body 4 (see FIG. 2 to FIG. 4).

The fixed body 2 has, for example, a chassis 5 formed of a magnetic metal material in a rectangular plate shape facing the front-rear direction and each of necessary parts attached to the chassis 5 (see FIG. 2).

A first operation magnet 6 and a second operation magnet 7 are attached to upper end parts of the chassis 5 to be separated to the left and right sides. A third operation magnet 8 and a fourth operation magnet 9 are attached to substantially the center part of the chassis 5 in the top-bottom direction to be separated to the left and right sides, and thus the third operation magnet 8 and the fourth operation magnet 9 are each attached to both the left and right end parts of the chassis 5.

A first operation yoke 10, a second operation yoke 11, a third operation yoke 12, and a fourth operation yoke 13 are attached to the chassis 5 while covering each of the first operation magnet 6, the second operation magnet 7, the third operation magnet 8, and the fourth operation magnet 9 from the front sides thereof. The first operation yoke 10 and the second operation yoke 11 are formed to have shapes that are penetrated from the top to the bottom, and the third operation yoke 12 and the fourth operation yoke 13 are formed to have shapes that are penetrated from the left to the right.

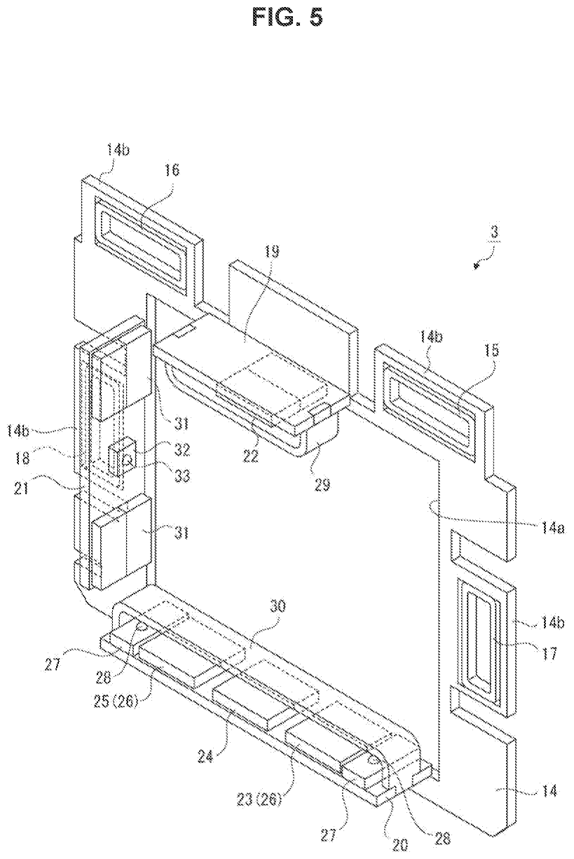

The support body 3 has, for example, a frame-shaped part 14 that is formed of a resin material to have a planar frame shape facing the front-rear direction and each of necessary parts attached to the frame-shaped part 14 (see FIG. 5).

The frame-shaped part 14 has an inner space formed as a disposition hole 14a. Coil attachment parts 14b and 14b protruding upward are provided at the upper end part of the frame-shaped part 14 to be separated to the left and right sides, and coil attachment parts 14b and 14b protruding to each of the left and right sides are provided at substantially a center part of the frame-shaped part 14 in the top-bottom direction.

A first operation coil 15, a second operation coil 16, a third operation coil 17, and a fourth operation coil 18 are attached to the coil attachment parts 14b, 14b, . . . . Detection elements, which are not illustrated, are disposed on inner sides of each of the first operation coil 15, the second operation coil 16, the third operation coil 17, and the fourth operation coil 18.

A first disposition base 19 and a second disposition base 20 are attached to an upper end part and a lower end part of the inner circumferential part of the frame-shaped part 14, respectively. The first disposition base 19 and the second disposition base 20 are formed of, for example, a magnetic metal material in a horizontally long plate shape facing the top-bottom direction and are attached to the frame-shaped part 14 while protruding forward from the frame-shaped part 14.

A third disposition base 21 formed in a vertically long plate shape facing the left-right direction is attached to the right side part of the inner circumferential part of the frame-shaped part 14. The third disposition base 21 is attached to the frame-shaped part 14 while protruding forward from the frame-shaped part 14.

A first movability magnet 22 is attached to the bottom surface of the first disposition base 19. A second movability magnet 23, a third movability magnet 24, and a fourth movability magnet 25 are attached on the upper surface of the second disposition base 20 from the left side in order. The second movability magnet 23 and the fourth movability magnet 25 also function as first attracting magnets 26 and 26.

First spherical body support members 27 and 27, for example, which are formed of a metal material are attached on the upper surface of the second disposition base 20 to be separated to the left and right sides. One first spherical body support member 27 is positioned on the left side of the second movability magnet 23 and the other first spherical body support member 27 is positioned on the right side of the fourth movability magnet 25. The first spherical body support members 27 and 27 have recesses that open upward formed thereon, and first spherical bodies 28 and 28 are rollably supported in the respective recesses. The first spherical bodies 28 and 28 are formed of, for example, a metal material.

Since the first spherical body support members 27 and 27 are attached to the upper surface of the second disposition base 20 as described above to be separated from each other to the left and right sides, the first spherical bodies 28 and 28 are positioned in a row with the second movability magnet 23, the third movability magnet 24 and the fourth movability magnet 25 in the left-right direction.

Thus, since the first spherical bodies 28 and 28 are positioned in a row with the second movability magnet 23, the third movability magnet 24, and the fourth movability magnet 25 in a direction orthogonal to the optical axis direction, miniaturization in a direction orthogonal to the direction in which the first spherical bodies 28 and 28, the second movability magnet 23, the third movability magnet 24, and the fourth movability magnet 25 are aligned (the top-bottom direction) can be achieved.

A first movability yoke 29 is attached to the first disposition base 19 while covering the first movability magnet 22 from below. The first movability yoke 29 is formed in a shape that is penetrated from the front to the rear.

A second movability yoke 30 is attached to the second disposition base 20 while covering the second movability magnet 23, the third movability magnet 24, the fourth movability magnet 25, and the first spherical body support members 27 and 27 from the top. The second movability yoke 30 is formed in a shape that is penetrated from the front to the rear.

Second attracting magnets 31 and 31 are attached to the left side surface (inner surface) of the third disposition base 21 to be separated from each other to the upper and lower sides. A second spherical body support member 32, for example that is formed of a metal material is attached to the left side surface of the third disposition base 21. The second spherical body support member 32 is positioned between the second attracting magnets 31 and 31. A recess opening to a side is formed in the second spherical body support member 32, and a second spherical body 33 is supported in the recess in a state in which the second spherical body is rollable. The second spherical body 33 is formed of, for example, a metal material.

Since the second spherical body support member 32 is attached to the left side surface of the third disposition base 21 as described above, the second spherical body 33 is positioned in a row with the second attracting magnets 31 and 31 in the top-bottom direction.

Thus, since the second spherical body 33 and the second attracting magnets 31 and 31 are positioned to be aligned with each other in a direction orthogonal to the optical axis direction, miniaturization in a direction orthogonal to the direction in which the second spherical body 33 and the second attracting magnets 31 and 31 are aligned (the left-right direction) can be achieved.

In addition, the first spherical body support members 27 and 27 are disposed on the second disposition base 20 on which the second movability magnet 23, the third movability magnet 24, and the fourth movability magnet 25 are disposed, and the second spherical body support member 32 is disposed on the third disposition base 21 on which the second attracting magnets 31 and 31 are disposed.

Thus, since the first spherical body support members 27 and 27 and the second spherical body support member 32 each supporting the first spherical bodies 28 and 28 and the second spherical body 33 are disposed on the second disposition base 20 and the third disposition base 21 on which each of the magnets is disposed, it is not necessary to provide each of disposition parts for disposing each of the magnets, the first spherical body support members 27 and 27, and the second spherical body support member 32 separately, and therefore miniaturization of the optical device 1 can be achieved due to a reduction in the number of components.

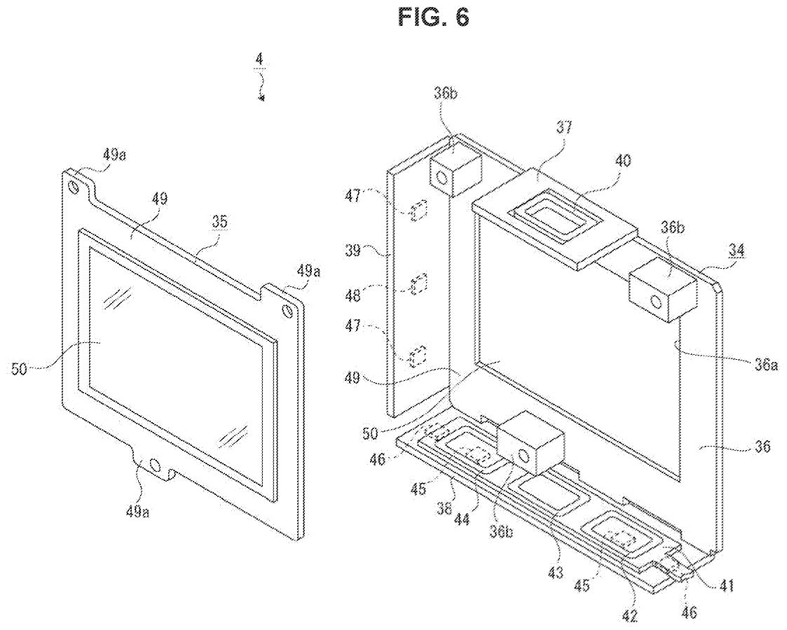

The movable body 4 has a holding base 34 and an optical body 35 (see FIG. 6).

The holding base 34 is formed of, for example, a resin material, and has a frame part 36 formed in a planar frame shape facing the front-rear direction, coil attachment parts 37 and 38 each protruding forward from both the upper and lower end parts of the frame part 36, and an attachment surface part 39 protruding forward from the right end part of the frame part 36.

The frame part 36 has an inner space formed as a hole 36a. The frame part 36 has attachment projection parts 36b, 36b, and 36b protruding forward and provided to be separated to the upper, lower, left, and right sides.

The coil attachment part 37 has a first movability coil 40 attached thereto. A flexible printed wiring board 41 is attached to the upper surface of the coil attachment part 38. A second movability coil 42, a third movability coil 43, and a fourth movability coil 44 are attached to the flexible printed wiring board 41 in order from the left side thereof. A detection element, for example, a Hall element which is not illustrated, is disposed in the inner side of each of the first movability coil 40, the second movability coil 42, the third movability coil 43, and the fourth movability coil 44.

Magnetic plates 45 and 45 are attached to the bottom surface of the coil attachment part 38 to be separated to the left and right sides. Receiving plates 46 and 46 are attached on the bottom surface of the coil attachment part 38 in the left-right direction at positions on the outer sides of the magnetic plates 45 and 45.

Magnetic plates 47 and 47 are attached to the right side surface (outer surface) of the attachment surface part 39 to be separated to the upper and lower sides. A receiving plate 48 is attached to the right side surface of the attachment surface part 39 at a position between the magnetic plates 47 and 47.

The optical body 35 has a holder 49 and an optical element 50, and the optical element 50 is attached to and held on the front side of the holder 49. Attachment reception projection parts 49a, 49a, and 49a are provided in the holder 49 to be separated to the upper, lower, left, and right sides. The optical body 35 is held by the holding base 34 by attaching each of the attachment reception projection parts 49a, 49a, and 49a to the attachment projection parts 36b, 36b, and 36b using screws or the like.

As the optical element 50, for example, an image sensor such as a charge coupled device (CCD) or a complementary metal-oxide semiconductor (CMOS) is used. Note that the optical element 50 is not limited to an image sensor, and may be another optical element, for example, a lens, iris blades, or the like.

The frame part 36 that is penetrated in optical axis direction (the front-rear direction) is provided in the movable body 4, and the attachment reception projection parts 49a, 49a, and 49a are attached to the attachment projection parts 36b, 36b, and 36b respectively to cause the optical element 50 to be held by the frame part 36 as described above.

Thus, since the movable body 4 has the frame part 36 in a shape that realizes a combination of high rigidity and a light weight, high rigidity and a light weight of the movable body 4 can be secured, and thereby a stable state of holding the optical element 50 can be obtained.

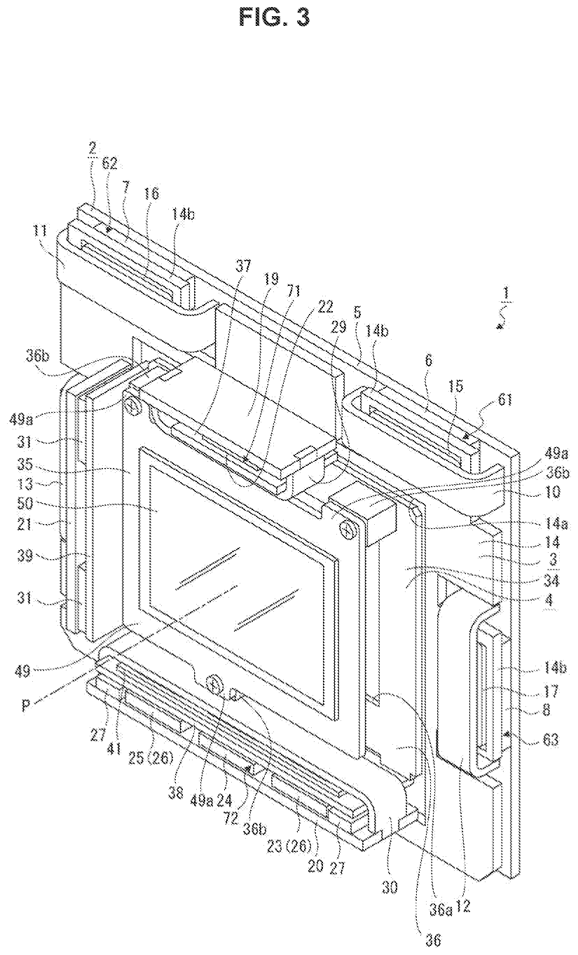

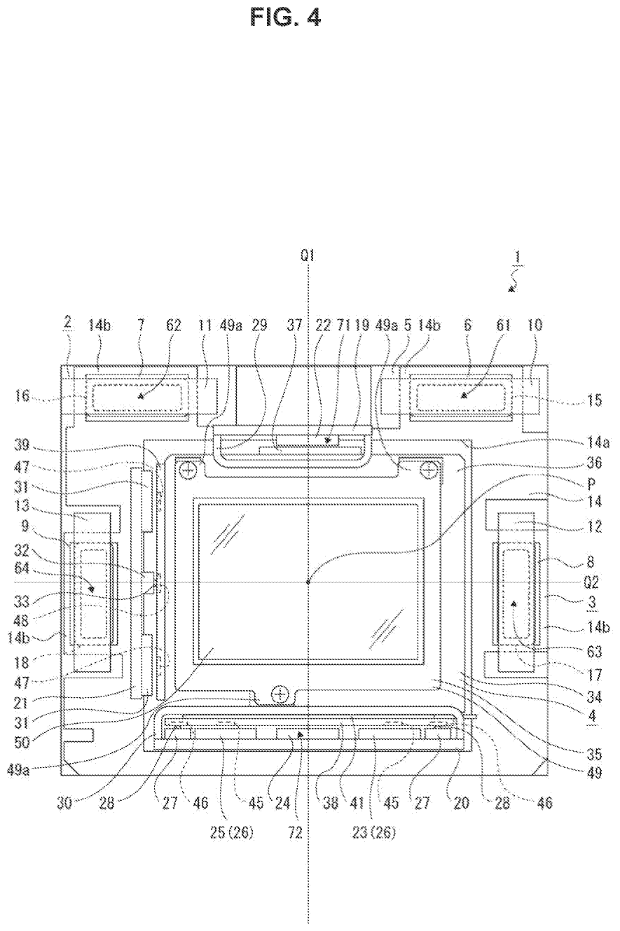

In the fixed body 2, the support body 3, the movable body 4 configured as described above, the support body 3 is movably and pivotably supported by the fixed body 2, and the movable body 4 is movably and pivotably supported by the support body 3 (see FIG. 3 and FIG. 4).

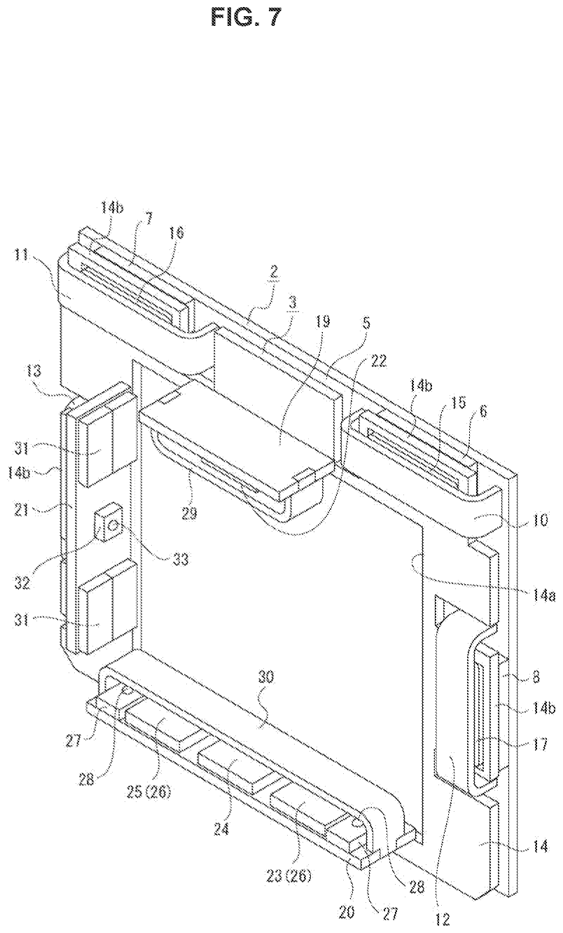

The support body 3 is supported by the fixed body 2 by inserting each of the coil attachment parts 14b, 14b, . . . between the first operation magnet 6 and the first operation yoke 10, between the second operation magnet 7 and the second operation yoke 11, between the third operation magnet 8 and the third operation yoke 12, and between the fourth operation magnet 9 and the fourth operation yoke 13 (see FIG. 7). In the state in which the coil attachment parts 14b, 14b, . . . are inserted as described above, the first operation coil 15 and the first operation magnet 6 are positioned back and forth having a uniform gap therebetween, the second operation coil 16 and the second operation magnet 7 are positioned back and forth having a uniform gap therebetween, the third operation coil 17 and the third operation magnet 8 are positioned back and forth having a uniform gap therebetween, and the fourth operation coil 18 and the fourth operation magnet 9 are positioned back and forth having a uniform gap therebetween.

In the state in which the support body 3 is supported by the fixed body 2 as described above, the support body 3 is positioned on the inner side of the outer circumference of the fixed body 2.

Thus, since the support body 3 is positioned on the inner side of the outer circumference of the fixed body 2, the movable body 4 is not positioned on the outer side of the outer circumference of the fixed body 2, and therefore miniaturization of the optical device 1 can be achieved.

In the state in which the support body 3 is supported by the fixed body 2, a first operation drive part 61 is formed by the first operation magnet 6, the first operation yoke 10, and the first operation coil 15, a second operation drive part 62 is formed by the second operation magnet 7, the second operation yoke 11, and the second operation coil 16, a third operation drive part 63 is formed by the third operation magnet 8, the third operation yoke 12, and the third operation coil 17, and a fourth operation drive part 64 is formed by the fourth operation magnet 9, the fourth operation yoke 13, and the fourth operation coil 18.

The first operation drive part 61, the second operation drive part 62, the third operation drive part 63, and the fourth operation drive part 64 are drive parts for causing the support body 3 to operate with respect to the fixed body 2, and thus when a current is applied to at least one of the first operation coil 15, the second operation coil 16, the third operation coil 17, or the fourth operation coil 18, the support body 3 is moved or pivoted with respect to the fixed body 2 in a predetermined direction in accordance with the direction of the current application.

Movement directions of the support body 3 with respect to the fixed body 2 are the left-right direction (X direction) that is a first movement direction and the top-bottom direction (Y direction) that is a second movement direction, the pivoting direction of the support body 3 with respect to the fixed body 2 is the direction around an optical axis P as a fulcrum (rolling direction) whose axial direction is the front-rear direction.

Note that the example in which the first operation magnet 6, the second operation magnet 7, the third operation magnet 8, and the fourth operation magnet 9 are attached to the fixed body 2 and the first operation coil 15, the second operation coil 16, the third operation coil 17, and the fourth operation coil 18 are attached to the support body 3 has been described above. However, the positional relations of the magnets and the coils may be reversed, and thus the first operation coil 15, the second operation coil 16, the third operation coil 17, and the fourth operation coil 18 may be attached to the fixed body 2 and the first operation magnet 6, the second operation magnet 7, the third operation magnet 8, and the fourth operation magnet 9 may be attached to the support body 3.

However, since the weight of a coil is generally lighter than the weight of a magnet, when the first operation coil 15 and the like are attached to the support body 3, a light weight of the support body 3, which is on the side to be caused to operate, can be achieved, a high speed of operations can be achieved, an amount of a current application to the first operation coil 15 and the like can be reduced, and thus power saving can be achieved.

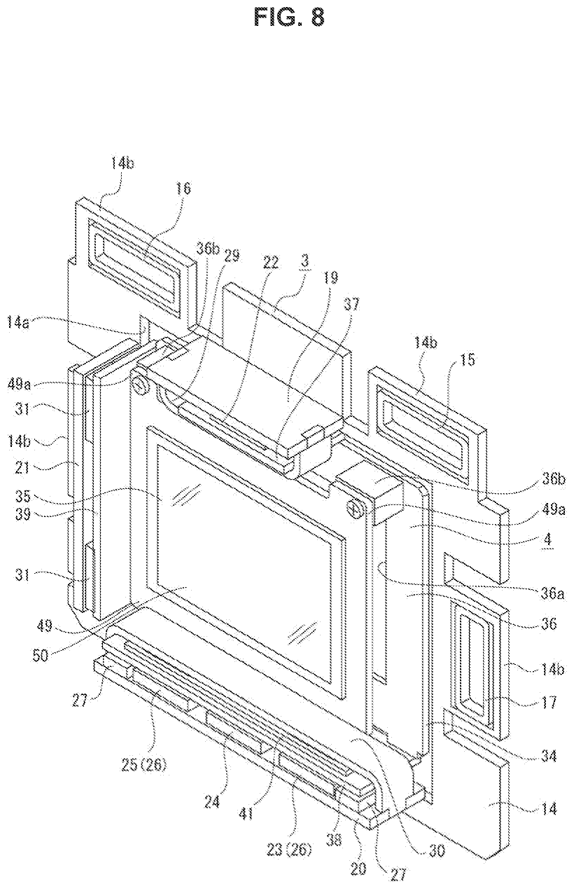

The coil attachment part 37 of the movable body 4 is inserted between the first movability magnet 22 and the first movability yoke 29, the coil attachment part 38 thereof is inserted between the flexible printed wiring board 42 and the second movability yoke 30 such that the movable body 4 is supported by the support body 3 (see FIG. 8).

In the state in which the coil attachment parts 37 and 38 are inserted as described above, the first movability coil 40 and the first movability magnet 22 are positioned on the upper and lower sides having a uniform gap therebetween, the second movability coil 42 and the second movability magnet 23 are positioned above and below having a uniform gap therebetween, the third movability coil 43 and the third movability magnet 24 are positioned above and below having a uniform gap therebetween, and the fourth movability coil 44 and the fourth movability magnet 25 are positioned above and below having a uniform gap therebetween.

In the state in which the movable body 4 is supported by the support body 3, the second movability magnet 23 and one magnetic plate 45 attached to the bottom surface of the coil attachment part 38 are positioned above and below facing each other, and the fourth movability magnet 25 and the other magnetic plate 45 attached to the bottom surface of the coil attachment part 38 are positioned above and below facing each other. Thus, the magnetic plates 45 and 45 are attracted by the second movability magnet 23 (the first attracting magnet 26) and the fourth movability magnet 25 (the first attracting magnet 26) respectively, the movable body 4 is energized against the support body 3 and is drawn downward.

The second movability magnet 23 (the first attracting magnet 26), the fourth movability magnet 25 (the first attracting magnet 26), and the magnetic plates 45 and 45 function as a first energizing mechanism that energizes the movable body 4 downward.

In addition, in the state in which the movable body 4 is supported by the support body 3, one second attracting magnet 31 and one magnetic plate 47 attached to the right side surface of the attachment surface part 39 are positioned to the left and right to face each other, and the other second attracting magnet 31 and the other magnetic plate 47 attached to the right side surface of the attachment surface part 39 are positioned to the left and right to face each other. Thus, the magnetic plates 47 and 47 are attracted by the second attracting magnets 31 and 31 respectively, and thus the movable body 4 is energized against the support body 3 and is drawn to the right side.

The second attracting magnets 31 and 31 and the magnetic plates 47 and 47 function as a second energizing mechanism that energizes the movable body 4 to the right side.

In the state in which the movable body 4 is supported by the support body 3 as described above, a first movability drive part 71 is formed by the first movability magnet 22, the first movability yoke 29, and the first movability coil 40, and a second movability drive part 72 is formed by the second movability magnet 23, the second movability coil 42, the third movability magnet 24, the third movability coil 43, the fourth movability magnet 25, the fourth movability coil 44, and the second movability yoke 30.

The first movability drive part 71 and the second movability drive part 72 are drive parts for causing the movable body 4 to operate with respect to the support body 3, and the movable body 4 is moved or pivoted with respect to the support body 3 in a predetermined direction in accordance with a current application when a current is applied to at least one of the first movability coil 40, the second movability coil 42, the third movability coil 43, or the fourth movability coil 44.

The movement direction of the movable body 4 with respect to the support body 3 is the front-rear direction (Z direction), and the pivoting directions of the movable body 4 with respect to the support body 3 are a direction around the axis of a first fulcrum axis Q1 (yawing direction) which is orthogonal to the optical axis P and whose axial direction is the top-bottom direction and a direction around the axis of a second fulcrum axis Q2 (pitching direction) which is orthogonal to both the optical axis P and the first fulcrum axis Q1 and whose axial direction is the left-right direction as illustrated in FIG. 4.

In the state in which the movable body 4 is supported by the support body 3, a part of the movable body 4 is inserted into a disposition hole 14a formed in the frame-shaped part 14 of the support body 3 for disposition, and thus the entire movable body is positioned on the inner side of the inner circumference of the frame-shaped part 14.

Since the movable body 4 body is positioned on the inner side of the inner circumference of the frame-shaped part 14 in the state in which the movable body 4 is supported by the support body 3 as described above, the movable body 4 is not positioned on the outer side of the inner circumference of the frame-shaped part 14, and thus miniaturization of the optical device 1 can be achieved.

In addition, the frame-shaped part 14 that is penetrated in optical axis direction (the front-rear direction) is provided in the support body 3.

Thus, since the support body 3 has the frame-shaped part 14 in a shape that realizes a combination of high rigidity and a light weight, high rigidity and a light weight of the support body 3 can be secured, and thereby a stable state of supporting the movable body 4 can be obtained.

In the state in which the movable body 4 is supported by the support body 3, the magnetic plates 45 and 45 are attracted by the second movability magnet 23 (the first attracting magnet 26) and the fourth movability magnet 25 (the first attracting magnet 26) respectively as described above, and thus the movable body 4 is energized against the support body 3 and is drawn downward.

Since the movable body 4 is drawn downward with respect to the support body 3 as described above, the receiving plates 46 and 46 attached to the bottom surface of the coil attachment part 38 are pushed against the first spherical bodies 28 and 28 respectively, and thus the movable body 4 is supported by the support body 3 in the top-bottom direction via the first spherical bodies 28 and 28.

Meanwhile, in the state in which the movable body 4 is supported by the support body 3, the magnetic plates 47 and 47 are attracted by the second attracting magnets 31 and 31 respectively, and thus the movable body 4 is energized against the support body 3 and is drawn to the right side as described above.

Since the movable body 4 is drawn to the right side of the support body 3 as described above, the receiving plate 48 attached to the right side surface of the attachment surface part 39 is pushed against the second spherical body 33, and thus the movable body 4 is supported by the support body 3 in the left-right direction via the second spherical body 33.

Note that the example in which the first movability magnet 22, the second movability magnet 23, the third movability magnet 24, and the fourth movability magnet 25 are attached to the support body 3 and the first movability coil 40, the second movability coil 42, the third movability coil 43, and the fourth movability coil 44 are attached to the movable body 4 has been introduced as described above. However, the positional relations between the magnets and the coils may be reversed, and thus the first movability coil 40, the second movability coil 42, the third movability coil 43, and the fourth movability coil 44 may be attached to the support body 3, and the first movability magnet 22, the second movability magnet 23, the third movability magnet 24, and the fourth movability magnet 25 may be attached to the movable body 4.

However, since the weight of a coil is generally lighter than the weight of a magnet, when the first movability coil 40 and the like are attached to the movable body 4, a light weight of the movable body 4, which is on the side to be caused to operate, can be achieved, a high speed of operations can be achieved, an amount of a current application to the first movability coil 40 and the like can be reduced, and thus power saving can be achieved.

### <Operation of Optical Device>

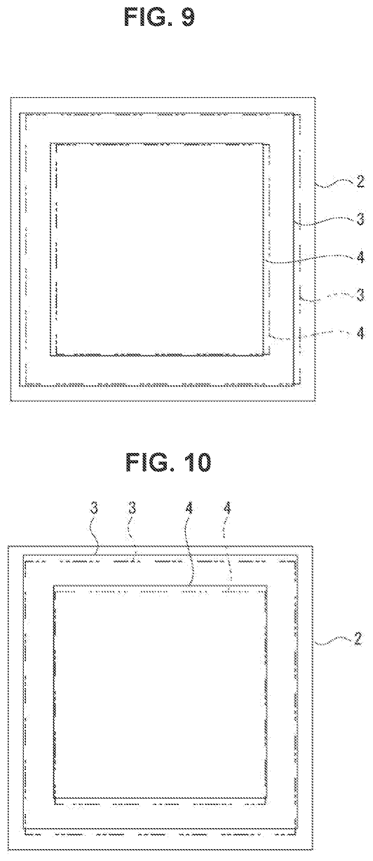

An operation of the optical device 1 will be described below (with reference to FIG. 9 to FIG. 14).

Note that FIG. 9 to FIG. 14 are illustrated in a simplified manner to make it easy to understand an operation state, and thus with respect to the support body 3 or the movable body 4 to be caused to operate, a state before an operation will be indicated by two-dot chain lines and a state after an operation will be indicated by solid lines. In addition, with respect to movement operations in the left-right direction (X direction) and in the top-bottom direction (Y direction) illustrated in FIG. 9 and FIG. 10, some lines of the support body 3 and the movable body 4 in the state before an operation and the state after an operation overlap each other, and thus overlapping lines in FIG. 9 are depicted to be slightly shifted in the top-bottom direction and overlapping lines in FIG. 10 are depicted to be slightly shifted in the left-right direction in order to make it easy to understand an operation state.

First, an operation of the support body 3 with respect to the fixed body 2 will be described (see FIG. 9 to FIG. 11). Since the movable body 4 is supported by the support body 3, when the support body 3 is caused to operate with respect to the fixed body 2, the movable body 4 is caused to operate integrally with the support body 3.

When a current is applied to the third operation coil 17 of the third operation drive part 63 and the fourth operation coil 18 of the fourth operation drive part 64 in the same direction, the support body 3 is moved with respect to the fixed body 2 in the X direction, and the movable body 4 is also moved with respect to the fixed body 2 in the X direction integrally with the support body 3 (see FIG. 9). At this time, the positions of the third operation magnet 8 and the fourth operation magnet 9 are detected by each of detection elements disposed on the inner sides of the third operation coil 17 and the fourth operation coil 18, and the movement position of the support body 3 with respect to the fixed body 2 in the X direction is ascertained on the basis of the detection results.

When a current is applied to the first operation coil 15 of the first operation drive part 61 and the second operation coil 16 of the second operation drive part 62 in the same direction (the same phase), the support body 3 is moved with respect to the fixed body 2 in the Y direction, and the movable body 4 is also moved with respect to the fixed body 2 in the Y direction integrally with the support body 3 (see FIG. 10). At this time, the positions of the first operation magnet 6 and the second operation magnet 7 are detected by each of the detection elements disposed on the inner sides of the first operation coil 15 and the second operation coil 16, and the movement position of the support body 3 with respect to the fixed body 2 in the Y direction is ascertained on the basis of the detection results.

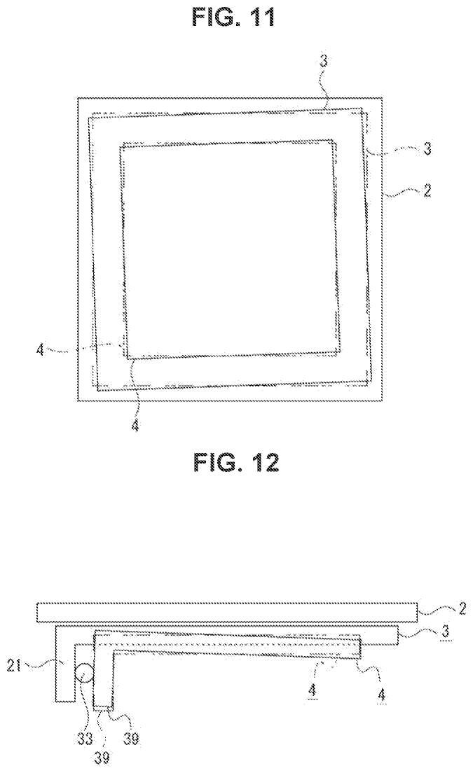

When a current is applied to the first operation coil 15 of the first operation drive part 61 and the second operation coil 16 of the second operation drive part 62 in the opposite direction (the opposite phase), the support body 3 is pivoted with respect to the fixed body 2 in the rolling direction, and the movable body 4 is also pivoted with respect to the fixed body 2 in the rolling direction integrally with the support body 3 (see FIG. 11). At this time, the positions of the first operation magnet 6 and the second operation magnet 7 are detected by each of the detection elements disposed on the inner sides of the first operation coil 15 and the second operation coil 16, and the pivoting position of the support body 3 with respect to the fixed body 2 in the rolling direction is ascertained on the basis of the detection results.

Next, an operation of the movable body 4 with respect to the support body 3 will be described (with reference to FIG. 12 to FIG. 14). An operation of the movable body 4 with respect to the support body 3 is performed in a state in which the movable body 4 is energized downward against the support body 3 and thus the receiving plates 46 and 46 are pushed against the first spherical bodies 28 and 28 respectively, and the movable body 4 is energized to the right side against the support body 3 and thus the receiving plate 48 is pushed against the second spherical body 33. Thus, when the movable body 4 is caused to operate with respect to the support body 3, the first spherical bodies 28 and 28 and the second spherical body 33 roll against the first spherical body support members 27 and 27, the second spherical body support member 32, and the receiving plates 46, 46, and 48.

In a state in which a current is applied to the first movability coil 40 of the first movability drive part 71 and the third movability coil 43 of the second movability drive part 72 in the same direction, when a current is applied to the second movability coil 42 and the fourth movability coil 44 of the second movability drive part 72 in the opposite direction, the movable body 4 is pivoted with respect to the support body 3 in the yawing direction (see FIG. 12). At this time, the positions of the first movability magnet 22, the second movability magnet 23, the third movability magnet 24, and the fourth movability magnet 25 are detected by each of the detection elements disposed on the inner sides of the first movability coil 40, the second movability coil 42, the third movability coil 43, and the fourth movability coil 44, and the pivoting position of the movable body 4 with respect to the support body 3 in the yawing direction is ascertained on the basis of the detection results.

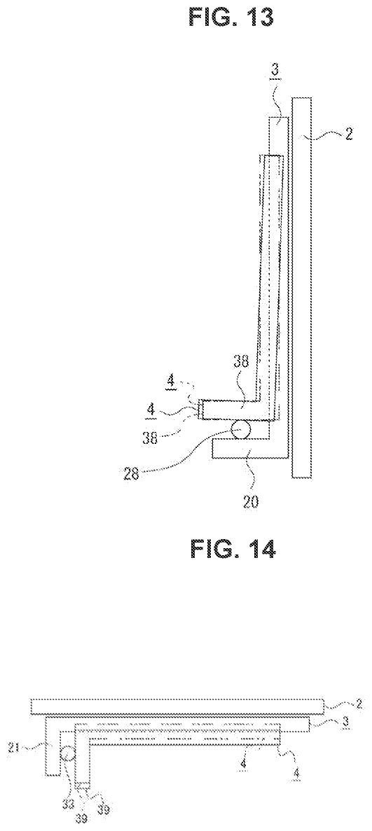

When currents are applied to the first movability coil 40 of the first movability drive part 71 and the second movability coil 42, the third movability coil 43, and the fourth movability coil 44 of the second movability drive part 72 in opposite directions, the movable body 4 is pivoted with respect to the support body 3 in the pitching direction (see FIG. 13). At this time, the positions of the first movability magnet 22, the second movability magnet 23, the third movability magnet 24, and the fourth movability magnet 25 are detected by each of the detection elements disposed on the inner sides of the first movability coil 40, the second movability coil 42, the third movability coil 43, and the fourth movability coil 44, and the pivoting position of the movable body 4 with respect to the support body 3 in the pitching direction is ascertained on the basis of the detection results.

Note that pivoting of the movable body 4 with respect to the support body 3 in the pitching direction may be performed in a state in which no current is applied to the third movability coil 43 and currents are applied to the first movability coil 40, and the second movability coil 42 and the fourth movability coil 44 in the opposite directions. In addition, pivoting of the movable body 4 with respect to the support body 3 in the pitching direction may also be performed in a state in which no current is applied to the second movability coil 42 and the fourth movability coil 44 and currents are applied to the first movability coil 40 and the third movability coil 43 in the opposite directions.

When a current is applied to the first movability coil 40 of the first movability drive part 71 and the second movability coil 42, the third movability coil 43, and the fourth movability coil 44 of the second movability drive part 72 in the same direction, the movable body 4 is moved with respect to the support body 3 in the Z direction (the optical axis direction) (see FIG. 14). At this time, the positions of the first movability magnet 22, the second movability magnet 23, the third movability magnet 24, and the fourth movability magnet 25 are detected by each of the detection elements disposed on the inner sides of the first movability coil 40, the second movability coil 42, the third movability coil 43, and the fourth movability coil 44, and the movement position of the movable body 4 with respect to the support body 3 in the Z direction is ascertained on the basis of the detection results.

Note that the movement of the movable body 4 with respect to the support body 3 in the optical axis direction may be performed by applying a current only to the first movability coil 40, the second movability coil 42, and the fourth movability coil 44 in the same direction or may be performed by applying a current only to the first movability coil 40 and the third movability coil 43 in the same direction.

### <Others>

Although the movable body 4 is moved with respect to the support body 3 in the Z direction (the optical axis direction) in the above-described optical device 1, it is desirable to provide a movement regulating part in order to prevent the movable body 4 from being detached from the support body 3 at the time of movement in the Z direction or the movable body 4 from excessively moving in the Z direction.

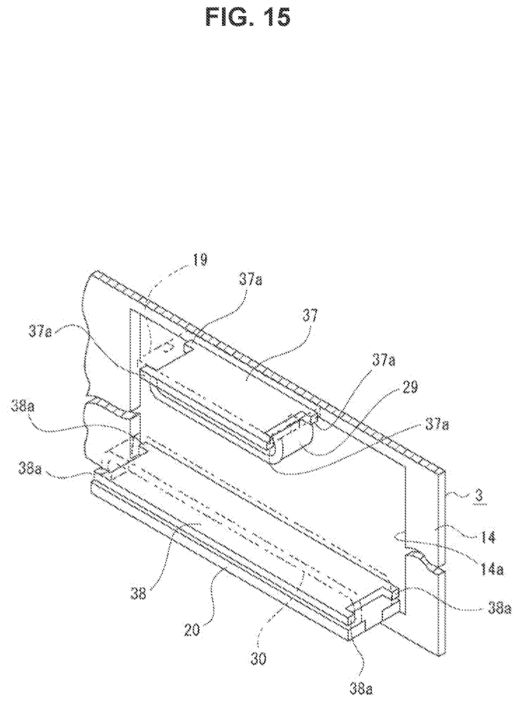

For example, movement regulating parts 37a, 37a, . . . , 38a, 38a, . . . protruding outwards can be provided at both the front and rear end parts of the coil attachment part 37 and both the front and rear end parts of the coil attachment part 38 of the movable body 4 (see FIG. 15). Since the movement regulating parts 37a and 38a can come in contact with the both the front and rear surfaces of the first movability yoke 29 and both the front and rear surfaces of the second movability yoke 30 by providing the movement regulating parts 37a and 38a when the movable body 4 is moved with respect to the support body 3 in the Z direction, movement of the movable body 4 is regulated at the contact positions.

In addition, the example in which the first attracting magnets 26 and 26 and the second attracting magnets 31 and 31 are provided in the support body 3 and the magnetic plates 45, 45, 47, and 47 are provided in the movable body 4 to form the first energizing mechanism and the second energizing mechanism has been introduced above. Conversely, the magnetic plates 45, 45, 47, and 47 may be provided in the support body 3 and the first attracting magnets 26 and 26 and the second attracting magnets 31 and 31 may be provided in the movable body 4 to form a first energizing mechanism and a second energizing mechanism.

Furthermore, the first energizing mechanism and the second energizing mechanism are not limited to including magnets and magnetic plates, and may include an elastic member such as a spring to link the support body 3 to the movable body 4.

Furthermore, although the example in which the movable body 4 is energized downward and to the right side with respect to the support body 3 by the first energizing mechanism and the second energizing mechanism has been introduced above, it is sufficient if energizing directions of the movable body 4 by the first energizing mechanism and the second energizing mechanism are either of upward and downward directions and either of left and right directions.

### <Disposition Examples of Four Operation Drive Parts>

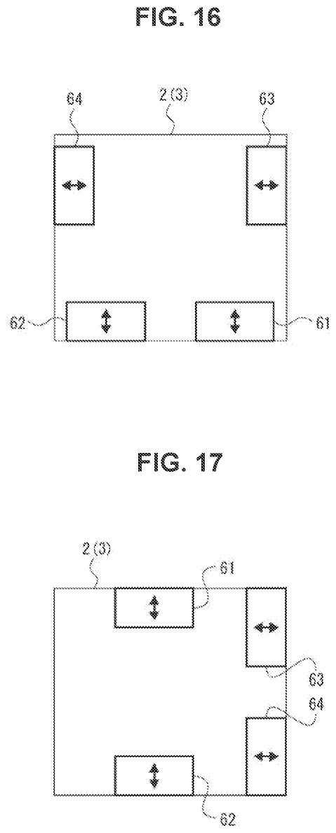

Disposition examples of the first operation drive part 61, the second operation drive part 62, the third operation drive part 63, and the fourth operation drive part 64 for causing the support body 3 to operate with respect to the fixed body 2 will be described below (with reference to FIG. 16 to FIG. 22). Note that, FIG. 16 to FIG. 22 schematically illustrate each of the parts to make it easy to understand the description.

The first operation drive part 61 and the second operation drive part 62 is operation drive parts for moving the support body 3 with respect to the fixed body 2 in the Y direction, and the third operation drive part 63 and the fourth operation drive part 64 are operation drive parts for moving the support body 3 with respect to the fixed body 2 in the X direction.

In a first disposition example, the first operation drive part 61 and the second operation drive part 62 are disposed to be separated to the left and right sides at the lower end part of the fixed body 2 (the support body 3), and the third operation drive part 63 and the fourth operation drive part 64 are disposed to be separated to the left and right sides above the first operation drive part 61 and the second operation drive part 62 as illustrated in FIG. 16.

In the first disposition example, the support body 3 is moved in the Y direction when thrust occurs in the first operation drive part 61 and the second operation drive part 62 in the same direction, and the support body 3 is moved in the X direction when thrust occurs in the third operation drive part 63 and the fourth operation drive part 64 in the same direction. In addition, for example, the support body 3 is pivoted in the rolling direction when thrust occurs in the first operation drive part 61 and the second operation drive part 62 in opposite directions.

In a second disposition example, the first operation drive part 61 and the second operation drive part 62 are disposed at both the upper and lower end parts of the fixed body 2 (the support body 3), and the third operation drive part 63 and the fourth operation drive part 64 are disposed to be separated to the upper and lower sides at the left side of the first operation drive part 61 and the second operation drive part 62 as illustrated in FIG. 17.

In the second disposition example, the support body 3 is moved in the Y direction when thrust occurs in the first operation drive part 61 and the second operation drive part 62 in the same direction, and the support body 3 is moved in the X direction when thrust occurs in the third operation drive part 63 and the fourth operation drive part 64 in the same direction. In addition, for example, the support body 3 is pivoted in the rolling direction when thrust occurs in the third operation drive part 63 and the fourth operation drive part 64 in opposite directions.

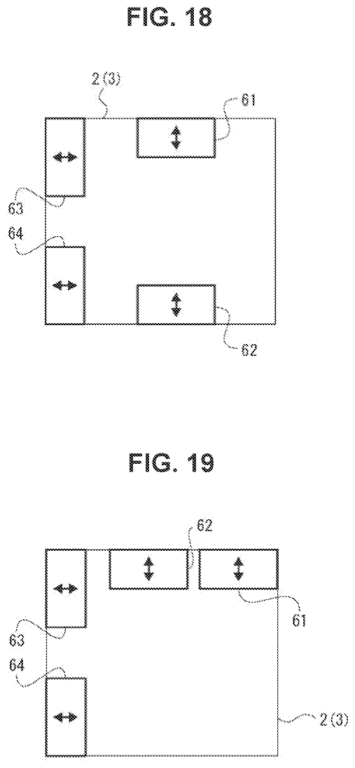

In a third disposition example, the first operation drive part 61 and the second operation drive part 62 are disposed at both the upper and lower end parts of the fixed body 2 (the support body 3), and the third operation drive part 63 and the fourth operation drive part 64 are disposed to be separated to the upper and lower sides at the right side of the first operation drive part 61 and the second operation drive part 62 as illustrated in FIG. 18.

In the third disposition example, the support body 3 is moved in the Y direction when thrust occurs in the first operation drive part 61 and the second operation drive part 62 in the same direction, and the support body 3 is moved in the X direction when thrust occurs in the third operation drive part 63 and the fourth operation drive part 64 in the same direction. In addition, for example, the support body 3 is pivoted in the rolling direction when thrust occurs in the third operation drive part 63 and the fourth operation drive part 64 in opposite directions.

In a fourth disposition example, the first operation drive part 61 and the second operation drive part 62 are disposed to be separated to the left and right sides at the upper end part of the fixed body 2 (the support body 3), and the third operation drive part 63 and the fourth operation drive part 64 are disposed to be separated to the upper and lower sides at the right end part of the fixed body 2 (the support body 3) as illustrated in FIG. 19.

In the fourth disposition example, the support body 3 is moved in the Y direction when thrust occurs in the first operation drive part 61 and the second operation drive part 62 in the same direction, and the support body 3 is moved in the X direction when thrust occurs in the third operation drive part 63 and the fourth operation drive part 64 in the same direction. In addition, for example, the support body 3 is pivoted in the rolling direction when thrust occurs in the first operation drive part 61 and the second operation drive part 62 in opposite directions or thrust occurs in the third operation drive part 63 and the fourth operation drive part 64 in opposite directions.

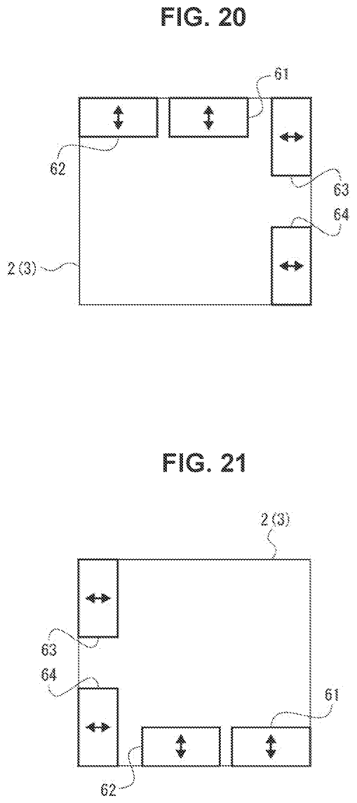

In a fifth disposition example, the first operation drive part 61 and the second operation drive part 62 are disposed to be separated to the left and right sides at the upper end part of the fixed body 2 (the support body 3), and the third operation drive part 63 and the fourth operation drive part 64 are disposed to be separated to the upper and lower sides at the left end part of the fixed body 2 (the support body 3) as illustrated in FIG. 20.

In the fifth disposition example, the support body 3 is moved in the Y direction when thrust occurs in the first operation drive part 61 and the second operation drive part 62 in the same direction, and the support body 3 is moved in the X direction when thrust occurs in the third operation drive part 63 and the fourth operation drive part 64 in the same direction. In addition, for example, the support body 3 is pivoted in the rolling direction when thrust occurs in the first operation drive part 61 and the second operation drive part 62 in opposite directions or thrust occurs in the third operation drive part 63 and the fourth operation drive part 64 in opposite directions.

In a sixth disposition example, the first operation drive part 61 and the second operation drive part 62 are disposed to be separated to the left and right sides at the lower end part of the fixed body 2 (the support body 3), and the third operation drive part 63 and the fourth operation drive part 64 are disposed to be separated to the upper and lower sides at the right end part of the fixed body 2 (the support body 3) as illustrated in FIG. 21.

In the sixth disposition example, the support body 3 is moved in the Y direction when thrust occurs in the first operation drive part 61 and the second operation drive part 62 in the same direction, and the support body 3 is moved in the X direction when thrust occurs in the third operation drive part 63 and the fourth operation drive part 64 in the same direction. In addition, for example, the support body 3 is pivoted in the rolling direction when thrust occurs in the first operation drive part 61 and the second operation drive part 62 in opposite directions or thrust occurs in the third operation drive part 63 and the fourth operation drive part 64 in opposite directions.

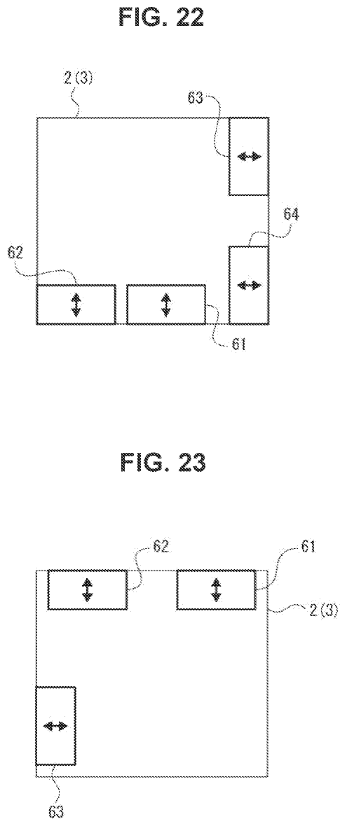

In a seventh disposition example, the first operation drive part 61 and the second operation drive part 62 are disposed to be separated to the left and right sides at the lower end part of the fixed body 2 (the support body 3), and the third operation drive part 63 and the fourth operation drive part 64 are disposed to be separated to the upper and lower sides at the left end part of the fixed body 2 (the support body 3) as illustrated in FIG. 22.

In the seventh disposition example, the support body 3 is moved in the Y direction when thrust occurs in the first operation drive part 61 and the second operation drive part 62 in the same direction, and the support body 3 is moved in the X direction when thrust occurs in the third operation drive part 63 and the fourth operation drive part 64 in the same direction. In addition, for example, the support body 3 is pivoted in the rolling direction when thrust occurs in the third operation drive part 63 and the fourth operation drive part 64 in opposite directions.

### <Disposition Examples of Three Operation Drive Parts>

Although the example in which the four operation drive parts are provided as configurations for causing the support body 3 to operate with respect to the fixed body 2 has been introduced above, a configuration for causing the support body 3 to operate with respect to the fixed body 2 may be a configuration in which three operation drive parts are provided as will be described below.

Disposition examples of three operation drive parts will be described below (see FIG. 23 to FIG. 30). Note that FIG. 23 to FIG. 30 schematically illustrate each of the parts in order to make it easy to understand the description.

All the disposition examples to be described below are those in which any one of the second operation drive part 62 or the fourth operation drive part 64 is provided in addition to the first operation drive part 61 and the third operation drive part 63. The first operation drive part 61 and the second operation drive part 62 are operation drive parts for moving the support body 3 with respect to the fixed body 2 in the Y direction, and the third operation drive part 63 and the fourth operation drive part 64 are operation drive parts for moving the support body 3 with respect to the fixed body 2 in the X direction.

In a first disposition example, the first operation drive part 61 and the second operation drive part 62 are disposed to be separated to the left and right sides at the upper end part of the fixed body 2 (the support body 3), and the third operation drive part 63 is disposed at the right end part of the fixed body 2 (the support body 3) below the first operation drive part 61 and the second operation drive part 62 as illustrated in FIG. 23.

In the first disposition example, the support body 3 is moved in the Y direction when thrust occurs in the first operation drive part 61 and the second operation drive part 62 in the same direction, and the support body 3 is moved in the X direction when thrust occurs in the third operation drive part 63. In addition, for example, the support body 3 is pivoted in the rolling direction when thrust occurs in the first operation drive part 61 and the second operation drive part 62 in opposite directions.

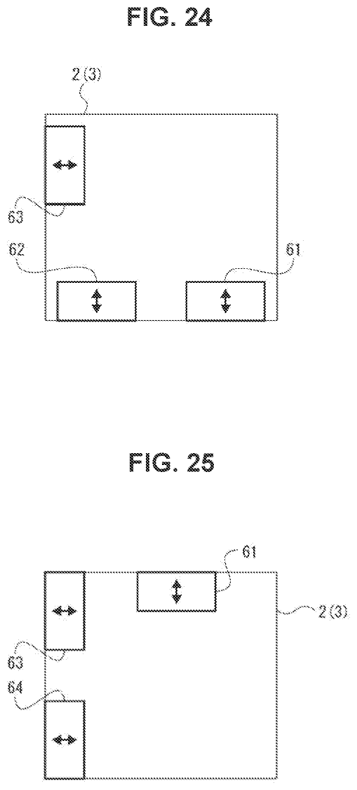

In a second disposition example, the first operation drive part 61 and the second operation drive part 62 are disposed to be separated to the left and right sides at the lower end part of the fixed body 2 (the support body 3), and the third operation drive part 63 is disposed at the right end part of the fixed body 2 (the support body 3) above the first operation drive part 61 and the second operation drive part 62 as illustrated in FIG. 24.

In the second disposition example, the support body 3 is moved in the Y direction when thrust occurs in the first operation drive part 61 and the second operation drive part 62 in the same direction, and the support body 3 is moved in the X direction when thrust occurs in the third operation drive part 63. In addition, for example, the support body 3 is pivoted in the rolling direction when thrust occurs in the first operation drive part 61 and the second operation drive part 62 in opposite directions.

In a third disposition example, the first operation drive part 61 is disposed at the upper end part of the fixed body 2 (the support body 3), and the third operation drive part 63 and the fourth operation drive part 64 are disposed to be separated to the upper and lower sides on the right side of the first operation drive part 61 as illustrated in FIG. 25.

In the third disposition example, the support body 3 is moved in the Y direction when thrust occurs in the first operation drive part 61, and the support body 3 is moved in the X direction when thrust occurs in the third operation drive part 63 and the fourth operation drive part 64 in the same direction. In addition, for example, the support body 3 is pivoted in the rolling direction when thrust occurs in the third operation drive part 63 and the fourth operation drive part 64 in opposite directions.

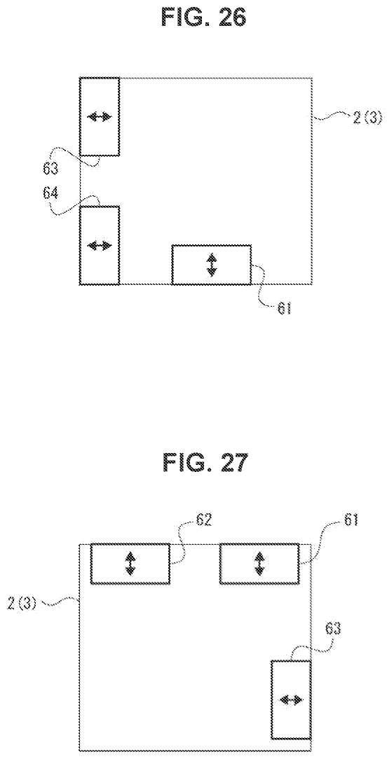

In a fourth disposition example, the first operation drive part 61 is disposed at the lower end part of the fixed body 2 (the support body 3), and the third operation drive part 63 and the fourth operation drive part 64 are disposed to be separated to the upper and lower sides on the right side of the first operation drive part 61 as illustrated in FIG. 26.

In the fourth disposition example, the support body 3 is moved in the Y direction when thrust occurs in the first operation drive part 61, and the support body 3 is moved in the X direction when thrust occurs in the third operation drive part 63 and the fourth operation drive part 64 in the same direction. In addition, for example, the support body 3 is pivoted in the rolling direction when thrust occurs in the third operation drive part 63 and the fourth operation drive part 64 in opposite directions.

In a fifth disposition example, the first operation drive part 61 and the second operation drive part 62 are disposed to be separated to the left and right sides at the upper end part of the fixed body 2 (the support body 3), and the third operation drive part 63 is disposed at the left end part of the fixed body 2 (the support body 3) below the first operation drive part 61 and the second operation drive part 62 as illustrated in FIG. 27.

In the fifth disposition example, the support body 3 is moved in the Y direction when thrust occurs in the first operation drive part 61 and the second operation drive part 62 in the same direction, and the support body 3 is moved in the X direction when thrust occurs in the third operation drive part 63. In addition, for example, the support body 3 is pivoted in the rolling direction when thrust occurs in the first operation drive part 61 and the second operation drive part 62 in opposite directions.

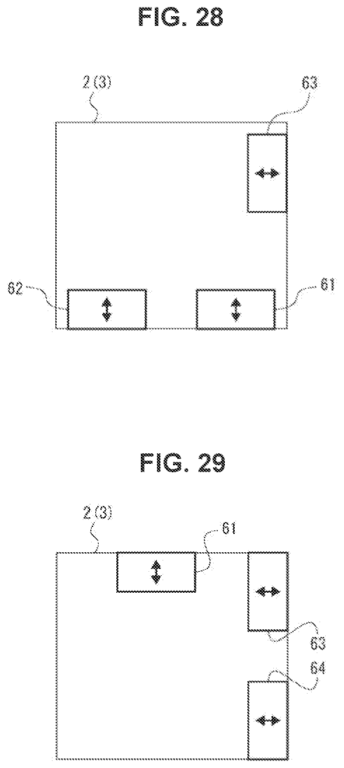

In a sixth disposition example, the first operation drive part 61 and the second operation drive part 62 are disposed to be separated to the left and right sides at the lower end part of the fixed body 2 (the support body 3), and the third operation drive part 63 is disposed at the left end part of the fixed body 2 (the support body 3) above the first operation drive part 61 and the second operation drive part 62 as illustrated in FIG. 28.

In the sixth disposition example, the support body 3 is moved in the Y direction when thrust occurs in the first operation drive part 61 and the second operation drive part 62 in the same direction, and the support body 3 is moved in the X direction when thrust occurs in the third operation drive part 63. In addition, for example, the support body 3 is pivoted in the rolling direction when thrust occurs in the first operation drive part 61 and the second operation drive part 62 in opposite directions.

In a seventh disposition example, the first operation drive part 61 is disposed at the upper end part of the fixed body 2 (the support body 3), and the third operation drive part 63 and the fourth operation drive part 64 are disposed to be separated to the upper and lower sides on the left end part of the fixed body 2 (the support body 3) as illustrated in FIG. 29.

In the seventh disposition example, the support body 3 is moved in the Y direction when thrust occurs in the first operation drive part 61, and the support body 3 is moved in the X direction when thrust occurs in the third operation drive part 63 and the fourth operation drive part 64 in the same direction. In addition, for example, the support body 3 is pivoted in the rolling direction when thrust occurs in the third operation drive part 63 and the fourth operation drive part 64 in opposite directions.

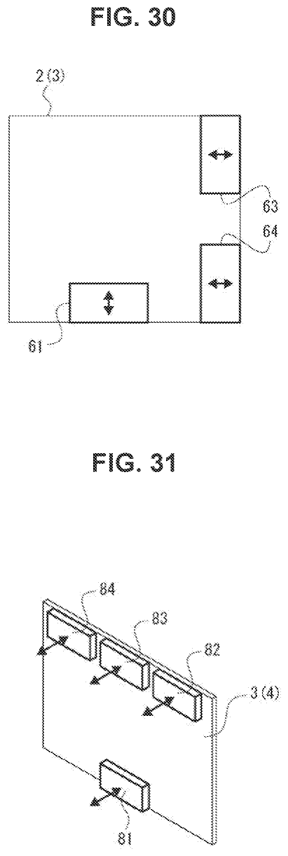

In an eighth disposition example, the first operation drive part 61 is disposed at the lower end part of the fixed body 2 (the support body 3), and the third operation drive part 63 and the fourth operation drive part 64 are disposed to be separated to the upper and lower sides on the left end part of the fixed body 2 (the support body 3) as illustrated in FIG. 30.

In the eighth disposition example, the support body 3 is moved in the Y direction when thrust occurs in the first operation drive part 61, and the support body 3 is moved in the X direction when thrust occurs in the third operation drive part 63 and the fourth operation drive part 64 in the same direction. In addition, for example, the support body 3 is pivoted in the rolling direction when thrust occurs in the third operation drive part 63 and the fourth operation drive part 64 in opposite directions.

As described above, three operation drive parts for causing the support body 3 to operate with respect to the fixed body 2 are provided, two operation drive parts are disposed to be separated in the axial direction of the first fulcrum axis (the top-bottom direction) or the axial direction of the second fulcrum axis (the left-right direction), and the operation drive part other than the two operation drive parts is disposed to be separated from the two operation drive parts in a direction orthogonal to the direction in which the two operation drive parts are connected.

Thus, since the support body 3 is caused to operate with respect to the fixed body 2 in the first movement direction, the second movement direction, and the direction around the optical axis by the three operation drive parts, the support body 3 is caused to operate by a small number of operation drive parts, and thus the support body 3 can be caused to operate with respect to the fixed body 2 in such a simple structure.

In addition, since the number of operation drive parts is small, a reduction in the number of components and a light weight of the imaging device 1 can be achieved.

### <Disposition Example of Movability Drive Parts Having Four Drive Parts>

The above-described first movability drive part 71 has the first movability magnet 22 and the first movability coil 40, and the second movability drive part 72 has the second movability magnet 23, the third movability magnet 24, the fourth movability magnet 25, the second movability coil 42, the third movability coil 43, and the fourth movability coil 44.

The first movability magnet 22 and the first movability coil 40 function as a first drive part, the second movability magnet 23 and the second movability coil 42 function as a second drive part, the third movability magnet 24 and the third movability coil 43 function as a third drive part, and the fourth movability magnet 25 and the fourth movability coil 44 function as a fourth drive part.

Disposition examples of the first drive part, the second drive part, the third drive part, and the fourth drive part will be described below (with reference to FIG. 31 to FIG. 35). Note that FIG. 31 to FIG. 35 schematically illustrate each of the parts in order to make it easy to understand the description.

The first drive part, the second drive part, the third drive part, and the fourth drive part will be described as a first drive part 81, a second drive part 82, a third drive part 83, and a fourth drive part 84, respectively, below. All the first drive part 81, the second drive part 82, the third drive part 83, and the fourth drive part 84 are drive parts that apply thrust to the movable body 4 in the front-rear direction (the optical axis direction).

Note that, although the first energizing mechanism that energizes the movable body 4 downward and the second energizing mechanism that energizes the movable body 4 to the right side are provided in the support body 3 and the movable body 4 as described above, the first energizing mechanism and the second energizing mechanism may be provided at any positions to be described in each example below, and description and illustration of the first energizing mechanism and the second energizing mechanism will be omitted.

In addition, the example in which the first energizing mechanism is constituted by the second movability magnet 23 (the first attracting magnet 26), the fourth movability magnet 25 (the first attracting magnet 26), and the magnetic plates 45 and 45 and the second energizing mechanism is constituted by the second attracting magnets 31 and 31 and the magnetic plates 47 and 47 has been introduced above. However, the magnets of the first energizing mechanism and the second energizing mechanism may be used also by any movability magnets, and dedicated magnets different from movability magnets may be used.

In a first disposition example, the first drive part 81 is disposed at the lower end part of the support body 3 (the movable body 4), the second drive part 82, the third drive part 83, and the fourth drive part 84 are disposed in order side by side in the left-right direction at the upper end part of and the support body 3 (the movable body 4) as illustrated in FIG. 31.

In the first disposition example, for example, the movable body 4 is pivoted in the yawing direction when thrust occurs in the second drive part 82 and the fourth drive part 84 in opposite directions, and for example, the movable body 4 is pivoted in the pitching direction when thrust occurs in the first drive part 81 and the third drive part 83 in opposite directions. In addition, for example, the movable body 4 is moved in the optical axis direction when thrust occurs in the first drive part 81 and the third drive part 83 in the same direction.

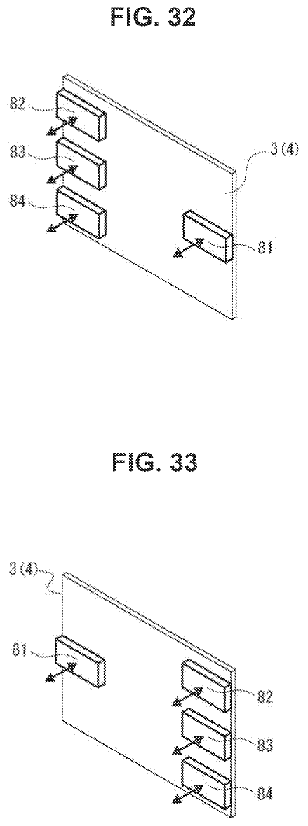

In a second disposition example, the first drive part 81 is disposed at the left end part of the support body 3 (the movable body 4), the second drive part 82, the third drive part 83, and the fourth drive part 84 are disposed in order side by side in the top-bottom direction at the right end part of and the support body 3 (the movable body 4) as illustrated in FIG. 32.

In the second disposition example, for example, the movable body 4 is pivoted in the yawing direction when thrust occurs in the first drive part 81 and the third drive part 83 in opposite directions, and for example, the movable body 4 is pivoted in the pitching direction when thrust occurs in the second drive part 82 and the fourth drive part 84 in opposite directions. In addition, for example, the movable body 4 is moved in the optical axis direction when thrust occurs in the first drive part 81 and the third drive part 83 in the same direction.

In a third disposition example, the first drive part 81 is disposed at the right end part of the support body 3 (the movable body 4), the second drive part 82, the third drive part 83, and the fourth drive part 84 are disposed in order side by side in the top-bottom direction at the left end part of and the support body 3 (the movable body 4) as illustrated in FIG. 33.

In the third disposition example, the movable body 4 is pivoted in the yawing direction when thrust occurs in the first drive part 81 and the third drive part 83 in opposite directions, and for example, for example, the movable body 4 is pivoted in the pitching direction when thrust occurs in the second drive part 82 and the fourth drive part 84 in opposite directions. In addition, for example, the movable body 4 is moved in the optical axis direction when thrust occurs in the first drive part 81 and the third drive part 83 in the same direction.

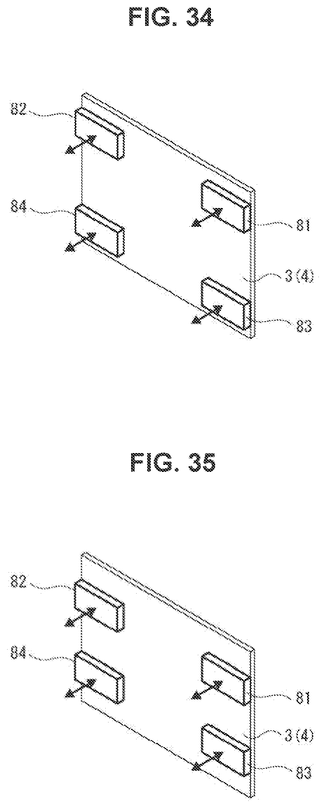

In a fourth disposition example, the first drive part 81 and the second drive part 82 are disposed to be separated to the left and right sides at the upper end part of the support body 3 (the movable body 4), and the third drive part 83 and the fourth drive part 84 are disposed to be separated to the left and right sides at the lower end part of the support body 3 (the movable body 4) as illustrated in FIG. 34.

In the fourth disposition example, for example, the movable body 4 is pivoted in the yawing direction when thrust occurs in the first drive part 81 and the third drive part 83 in the same direction and thrust occurs in the second drive part 82 and the fourth drive part 84 in the opposite direction with respect to the first drive part 81 and the third drive part 83, and for example, the movable body 4 is pivoted in the pitching direction when thrust occurs in the first drive part 81 and the second drive part 82 in the same direction and thrust occurs in the third drive part 83 and the fourth drive part 84 in the opposite direction with respect to the first drive part 81 and the second drive part 82. In addition, for example, the movable body 4 is moved in the optical axis direction when thrust occurs in the first drive part 81, the second drive part 82, the third drive part 83, and the fourth drive part 84 in the same direction.

In a fifth disposition example, the first drive part 81 and the third drive part 83 are disposed to be separated to the upper and lower sides at the left end part of the support body 3 (the movable body 4), and the second drive part 82 and the fourth drive part 84 are disposed to be separated to the upper and lower sides at the right end part of the support body 3 (the movable body 4) as illustrated in FIG. 35.

In the fifth disposition example, for example, the movable body 4 is pivoted in the yawing direction when thrust occurs in the first drive part 81 and the third drive part 83 in the same direction and thrust occurs in the second drive part 82 and the fourth drive part 84 in the opposite direction with respect to the first drive part 81 and the third drive part 83, and for example, the movable body 4 is pivoted in the pitching direction when thrust occurs in the first drive part 81 and the second drive part 82 in the same direction and thrust occurs in the third drive part 83 and the fourth drive part 84 in the opposite direction with respect to the first drive part 81 and the second drive part 82. In addition, for example, the movable body 4 is moved in the optical axis direction when thrust occurs in the first drive part 81, the second drive part 82, the third drive part 83, and the fourth drive part 84 in the same direction.

### <Disposition Example of Movability Drive Part Having Three Drive Parts>

Although the disposition examples of the movability drive part having the first drive part 81, the second drive part 82, the third drive part 83, and the fourth drive part 84 have been introduced above, the movability drive part can be constituted by the first drive part 81, the second drive part 82, and the third drive part 83 in the optical device 1.

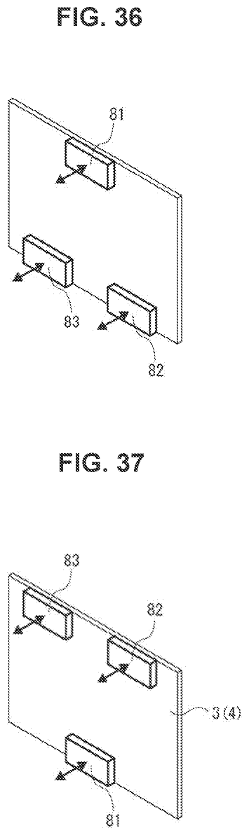

Disposition examples of the first drive part 81, the second drive part 82, and the third drive part 83 will be described below (with reference to FIG. 36 to FIG. 47). Note that FIG. 36 to FIG. 47 schematically illustrate each of the parts in order to make it easy to understand the description.

Note that the first energizing mechanism and the second energizing mechanism may be provided at any position and description and illustration of the first energizing mechanism and the second energizing mechanism will be omitted also in the following disposition examples. In addition, the magnets of the first energizing mechanism and the second energizing mechanism may be used also by any movability magnets, and dedicated magnets different from movability magnets may be used.

In a first disposition example, the first drive part 81 is disposed at the upper end part of the support body 3 (the movable body 4), and the second drive part 82 and the third drive part 83 are disposed to be separated to the left and right sides at the lower end part of the support body 3 (the movable body 4) as illustrated in FIG. 36.

In the first disposition example, for example, the movable body 4 is pivoted in the yawing direction when thrust occurs in the second drive part 82 and the third drive part 83 in opposite directions, and for example, the movable body 4 is pivoted in the pitching direction when thrust occurs in the first drive part 81 in one direction and thrust occurs in the second drive part 82 and the third drive part 83 in the opposite direction with respect to the first drive part 81. In addition, for example, the movable body 4 is moved in the optical axis direction when thrust occurs in the first drive part 81, the second drive part 82, and the third drive part 83 in the same direction.

In a second disposition example, the first drive part 81 is disposed at the lower end part of the support body 3 (the movable body 4), and the second drive part 82 and the third drive part 83 are disposed to be separated to the left and right sides at the upper end part of the support body 3 (the movable body 4) as illustrated in FIG. 37.

In the second disposition example, for example, the movable body 4 is pivoted in the yawing direction when thrust occurs in the second drive part 82 and the third drive part 83 in opposite directions, and for example, the movable body 4 is pivoted in the pitching direction when thrust occurs in the first drive part 81 in one direction and thrust occurs in the second drive part 82 and the third drive part 83 in the opposite direction with respect to the first drive part 81. In addition, for example, the movable body 4 is moved in the optical axis direction when thrust occurs in the first drive part 81, the second drive part 82, and the third drive part 83 in the same direction.

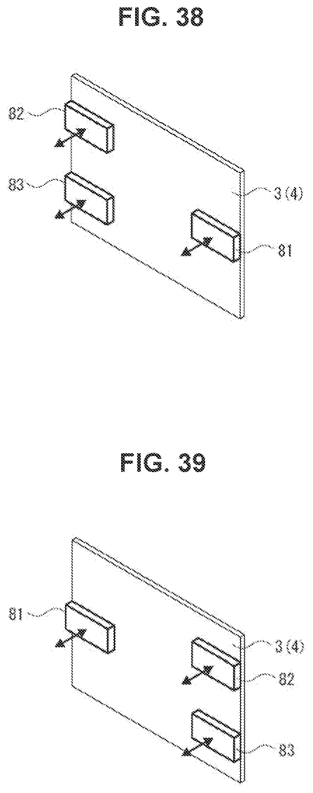

In a third disposition example, the first drive part 81 is disposed at the left end part of the support body 3 (the movable body 4), and the second drive part 82 and the third drive part 83 are disposed to be separated in the top-bottom direction at the right end part of the support body 3 (the movable body 4) as illustrated in FIG. 38.

In the third disposition example, for example, the movable body 4 is pivoted in the yawing direction when thrust occurs in the first drive part 81 in one direction and thrust occurs in the second drive part 82 and the third drive part 83 in the opposite direction with respect to the first drive part 81, and for example, the movable body 4 is pivoted in the pitching direction when thrust occurs in the second drive part 82 and the third drive part 83 in opposite directions. In addition, for example, the movable body 4 is moved in the optical axis direction when thrust occurs in the first drive part 81, the second drive part 82, and the third drive part 83 in the same direction.

In a fourth disposition example, the first drive part 81 is disposed at the right end part of the support body 3 (the movable body 4), and the second drive part 82 and the third drive part 83 are disposed to be separated in the top-bottom direction at the left end part of the support body 3 (the movable body 4) as illustrated in FIG. 39.

In the fourth disposition example, for example, the movable body 4 is pivoted in the yawing direction when thrust occurs in the first drive part 81 in one direction and thrust occurs in the second drive part 82 and the third drive part 83 in the opposite direction with respect to the first drive part 81, and for example, the movable body 4 is pivoted in the pitching direction when thrust occurs in the second drive part 82 and the third drive part 83 in opposite directions. In addition, for example, the movable body 4 is moved in the optical axis direction when thrust occurs in the first drive part 81, the second drive part 82, and the third drive part 83 in the same direction.

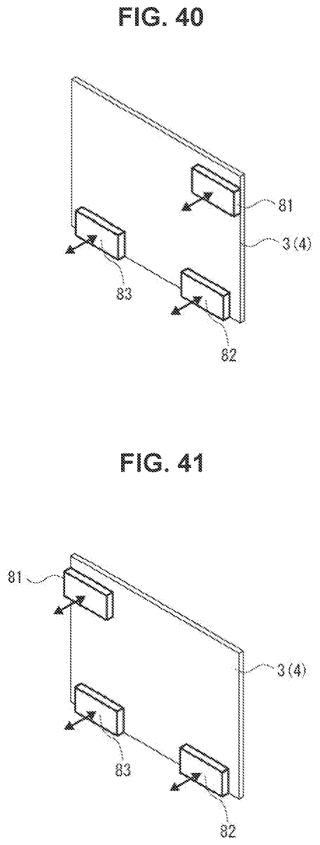

In a fifth disposition example, the first drive part 81 is disposed at the left end part of the support body 3 (the movable body 4), and the second drive part 82 and the third drive part 83 are disposed to be separated to the left and right sides at the lower end part of the support body 3 (the movable body 4) as illustrated in FIG. 40.

In the fifth disposition example, for example, the movable body 4 is pivoted in the yawing direction when thrust occurs in the second drive part 82 and the third drive part 83 in opposite directions, and for example, the movable body 4 is pivoted in the pitching direction when thrust occurs in the first drive part 81 in one direction and thrust occurs in the second drive part 82 and the third drive part 83 in the opposite direction with respect to the first drive part 81. In addition, for example, the movable body 4 is moved in the optical axis direction when thrust occurs in the first drive part 81, the second drive part 82, and the third drive part 83 in the same direction.

In a sixth disposition example, the first drive part 81 is disposed at the right end part of the support body 3 (the movable body 4), and the second drive part 82 and the third drive part 83 are disposed to be separated to the left and right sides at the lower end part of the support body 3 (the movable body 4) as illustrated in FIG. 41.

In the sixth disposition example, for example, the movable body 4 is pivoted in the yawing direction when thrust occurs in the second drive part 82 and the third drive part 83 in opposite directions, and for example, the movable body 4 is pivoted in the pitching direction when thrust occurs in the first drive part 81 in one direction and thrust occurs in the second drive part 82 and the third drive part 83 in the opposite direction with respect to the first drive part 81. In addition, for example, the movable body 4 is moved in the optical axis direction when thrust occurs in the first drive part 81, the second drive part 82, and the third drive part 83 in the same direction.

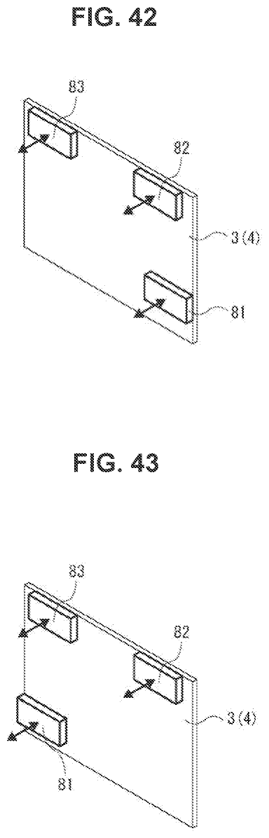

In a seventh disposition example, the first drive part 81 is disposed at the left end part of the support body 3 (the movable body 4), and the second drive part 82 and the third drive part 83 are disposed to be separated to the left and right sides at the upper end part of the support body 3 (the movable body 4) as illustrated in FIG. 42.

In the seventh disposition example, for example, the movable body 4 is pivoted in the yawing direction when thrust occurs in the second drive part 82 and the third drive part 83 in opposite directions, and for example, the movable body 4 is pivoted in the pitching direction when thrust occurs in the first drive part 81 in one direction and thrust occurs in the second drive part 82 and the third drive part 83 in the opposite direction with respect to the first drive part 81. In addition, for example, the movable body 4 is moved in the optical axis direction when thrust occurs in the first drive part 81, the second drive part 82, and the third drive part 83 in the same direction.

In an eighth disposition example, the first drive part 81 is disposed at the right end part of the support body 3 (the movable body 4), and the second drive part 82 and the third drive part 83 are disposed to be separated to the left and right sides at the upper end part of the support body 3 (the movable body 4) as illustrated in FIG. 43.

In the eighth disposition example, for example, the movable body 4 is pivoted in the yawing direction when thrust occurs in the second drive part 82 and the third drive part 83 in opposite directions, and for example, the movable body 4 is pivoted in the pitching direction when thrust occurs in the first drive part 81 in one direction and thrust occurs in the second drive part 82 and the third drive part 83 in the opposite direction with respect to the first drive part 81. In addition, for example, the movable body 4 is moved in the optical axis direction when thrust occurs in the first drive part 81, the second drive part 82, and the third drive part 83 in the same direction.

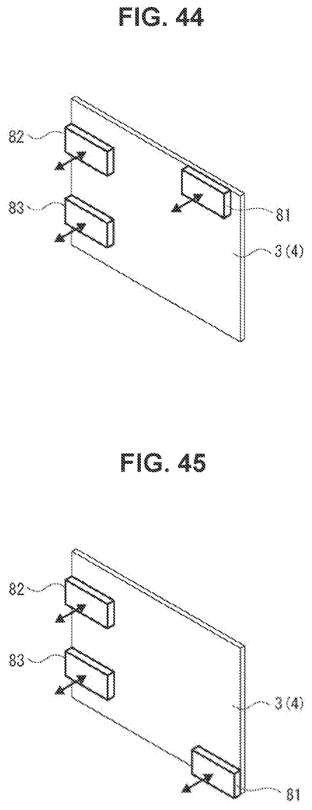

In a ninth disposition example, the first drive part 81 is disposed at the upper end part of the support body 3 (the movable body 4), and the second drive part 82 and the third drive part 83 are disposed to be separated in the top-bottom direction at the right end part of the support body 3 (the movable body 4) as illustrated in FIG. 44.

In the ninth disposition example, for example, the movable body 4 is pivoted in the yawing direction when thrust occurs in the first drive part 81 in one direction and thrust occurs in the second drive part 82 and the third drive part 83 in the opposite direction with respect to the first drive part 81, and for example, the movable body 4 is pivoted in the pitching direction when thrust occurs in the second drive part 82 and the third drive part 83 in opposite directions. In addition, for example, the movable body 4 is moved in the optical axis direction when thrust occurs in the first drive part 81, the second drive part 82, and the third drive part 83 in the same direction.

In a tenth disposition example, the first drive part 81 is disposed at the lower end part of the support body 3 (the movable body 4), and the second drive part 82 and the third drive part 83 are disposed to be separated in the top-bottom direction at the right end part of the support body 3 (the movable body 4) as illustrated in FIG. 45.

In the tenth disposition example, for example, the movable body 4 is pivoted in the yawing direction when thrust occurs in the first drive part 81 in one direction and thrust occurs in the second drive part 82 and the third drive part 83 in the opposite direction with respect to the first drive part 81, and for example, the movable body 4 is pivoted in the pitching direction when thrust occurs in the second drive part 82 and the third drive part 83 in opposite directions. In addition, for example, the movable body 4 is moved in the optical axis direction when thrust occurs in the first drive part 81, the second drive part 82, and the third drive part 83 in the same direction.

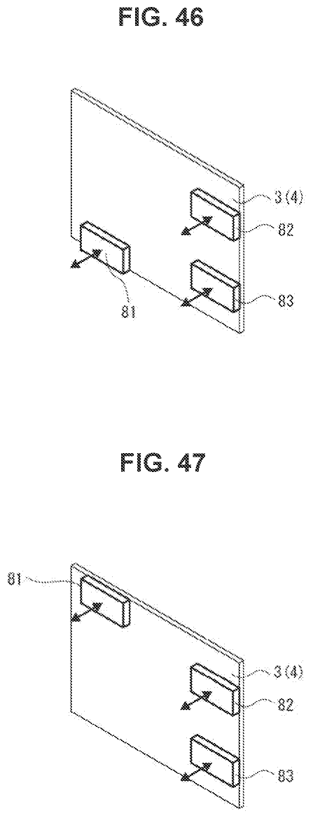

In an eleventh disposition example, the first drive part 81 is disposed at the lower end part of the support body 3 (the movable body 4), and the second drive part 82 and the third drive part 83 are disposed to be separated in the top-bottom direction at the left end part of the support body 3 (the movable body 4) as illustrated in FIG. 46.

In the eleventh disposition example, for example, the movable body 4 is pivoted in the yawing direction when thrust occurs in the first drive part 81 in one direction and thrust occurs in the second drive part 82 and the third drive part 83 in the opposite direction with respect to the first drive part 81, and for example, the movable body 4 is pivoted in the pitching direction when thrust occurs in the second drive part 82 and the third drive part 83 in opposite directions. In addition, for example, the movable body 4 is moved in the optical axis direction when thrust occurs in the first drive part 81, the second drive part 82, and the third drive part 83 in the same direction.

In a twelfth disposition example, the first drive part 81 is disposed at the upper end part of the support body 3 (the movable body 4), and the second drive part 82 and the third drive part 83 are disposed to be separated in the top-bottom direction at the left end part of the support body 3 (the movable body 4) as illustrated in FIG. 47.

In the twelfth disposition example, for example, the movable body 4 is pivoted in the yawing direction when thrust occurs in the first drive part 81 in one direction and thrust occurs in the second drive part 82 and the third drive part 83 in the opposite direction with respect to the first drive part 81, and for example, the movable body 4 is pivoted in the pitching direction when thrust occurs in the second drive part 82 and the third drive part 83 in opposite directions. In addition, for example, the movable body 4 is moved in the optical axis direction when thrust occurs in the first drive part 81, the second drive part 82, and the third drive part 83 in the same direction.

Since the movability drive part is constituted by the three drive parts including the first drive part 81, the second drive part 82, and the third drive part 83 and the support body 3 is caused to operate with respect to the fixed body 2 by the three drive parts in the first movement direction, the second movement direction, and the direction around the optical axis, the support body 3 can be caused to operate by the small number of drive parts, and thus the support body 3 can be caused to operate with respect to the fixed body 2 in such a simple structure.

In addition, since the number of drive parts is small, a reduction in the number of components and a light weight of the imaging device 1 can be achieved.

### <Embodiment of Imaging Device>

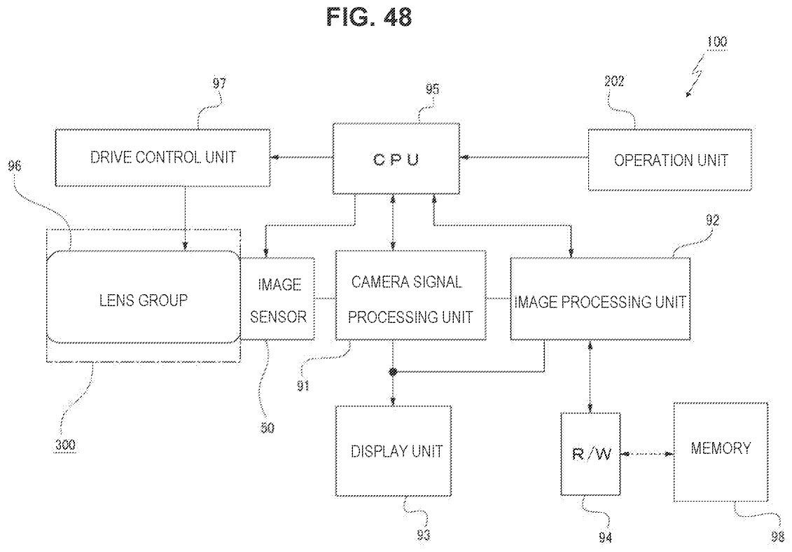

FIG. 48 is a block diagram of a video camera according to an embodiment of an imaging device of the present technology.

The imaging device 100 has the interchangeable lens 300 that is responsible for an imaging function, a camera signal processing unit 91 that processes signals such as an analog-digital conversion of a signal of a captured image, and an image processing unit 92 that performs a recording/reproduction process of an image of a signal. In addition, the imaging device 100 includes a display unit (display) 93 that displays a captured image and the like, a R/W (reader/writer) 94 that writes and reads a signal of an image on and from a memory 98, a central processing unit (CPU) 95 that controls the entire imaging device 100, an operation part 202 with which necessary operations are performed by a user such as various switches, and a drive control unit 97 that controls drive of a lens group 96 and the like disposed in the interchangeable lens 300.

The camera signal processing unit 91 performs various kinds of signal processing such as a conversion to a digital signal, noise removal, correction of image quality, and a conversion to a luminance/color difference signal on an output signal from an optical element (image sensor) 50.

The image processing unit 92 performs a compression encoding/decompression decoding processes of an image signal based on a predetermined image data format, a conversion process of data specifications such as resolution, and the like.

The display unit 93 has a function of displaying a state of an operation with respect to the operation part 202 by a user and various types of data such as captured images. Note that the display unit 93 may not be provided in the imaging device 100 and data of a captured image may be transmitted to another display device to display the image.

The R/W 94 performs writing of image data encoded by the image processing unit 92 onto the memory 98 and reading of image data recorded in the memory 98.

The CPU 95 functions as a control processing unit that controls each of circuit blocks provided in the imaging device 100 and controls each of the circuit blocks on the basis of an instruction input signal or the like from the operation part 202.

The operation part 202 outputs an instruction input signal to the CPU 95 in accordance with an operation by a user.

The drive control unit 97 controls a drive source that causes the lens group 96 to move on the basis of a control signal from the CPU 95, for example, a zoom motor, a focus motor, and the like.

The memory 98 is, for example, a semiconductor memory that can be detachable from a slot connected to the R/W 94.

An operation of the imaging device 100 will be described below.

In an imaging standby state, a signal of a captured image is output to the display unit 93 via the camera signal processing unit 91 under control of the CPU 95 and is displayed as a camera-through image. In addition, when an instruction input signal is input from the operation part 202, the CPU 95 outputs a control signal to the drive control unit 97 and thus the lens group 96 is moved on the basis of control of the drive control unit 97.

When a photographing operation is performed on the basis of the instruction input signal from the operation part 202, the signal of a captured image is output from the camera signal processing unit 91 to the image processing unit 92 to be subject to a compression encoding process and is converted into digital data of a predetermined data format. The converted data is output to the R/W 94 and written into the memory 98.

In a case in which image data recorded in the memory 98 is to be reproduced, predetermined image data is read from the memory 98 by the R/W 94 in accordance with an operation with respect to the operation part 202, a decompression decoding process is performed by the image processing unit 92, and then a reproduction image signal is output to the display unit 93 to display a reproduction image.

### <Conclusion>

As described above, in the optical device 1 and the imaging device 100, the movable body 4 is supported by the support body 3 via the first spherical bodies 28 and 28 and the second spherical body 33, and thus the movable body 4 can be moved with respect to the support body 3 in the optical axis direction and can be pivoted in the first pivoting direction with the first fulcrum axis Q1 as a fulcrum and the second pivoting direction with the second fulcrum axis Q2 as a fulcrum.

Thus, since the movable body 4 is caused to operate in the optical axis direction, the first pivoting direction, and the second pivoting direction in the state in which the movable body 4 is supported by the support body 3 via the first spherical bodies 28 and 28 and the second spherical body 33, the first spherical bodies 28 and 28 and the second spherical body 33 roll with respect to the movable body 4 and thereby the movable body 4 is caused to operate, thus a smooth operation state of the movable body 4 can be secured and then improvement in functionality can be achieved.

In addition, since a position of the optical element 50 in the optical axis direction can be freely adjusted, a shortest photographing distance can be further shortened without mounting a close-up adapter.

Furthermore, since the optical element 50 can be moved in the optical axis direction, the camera shake correction function and the auto-focus function in the optical axis direction can be executed, and dust adhering to the optical element 50 can be effectively dropped off.

Furthermore, due to pivot operations in the first pivoting direction with the first fulcrum axis Q1 as a fulcrum and the second pivoting direction with the second fulcrum axis Q2 as a fulcrum, various kinds of tilt photography including tilt and shift photography, pan-focus photography, miniature-like photography, and the like can be performed without mounting a tilt adapter.

In addition, since the movable body 4 is supported by the support body 3 via the two first spherical bodies 28 and 28, rotation of the movable body 4 with respect to the support body 3 in the direction around the optical axis is regulated, and the movable body 4 can be caused to operate with respect to the support body 3 in the optical axis direction, the first pivoting direction, and the second pivoting direction with high accuracy.

Note that, although the example in which the two first spherical bodies 28 and 28 and the one second spherical body 33 are provided has been introduced above, conversely, one first spherical body 28 and two second spherical bodies 33 and 33 may be provided. In addition, both first spherical bodies 28 and second spherical bodies 33 may be provided two or more in number.

Furthermore, the movable body 4 is energized in the direction in which the movable body 4 is pushed against the first spherical bodies 28 and 28 in the axial direction of the first fulcrum axis Q1.

Thus, the movable body 4 is pushed against the first spherical bodies 28 and 28 and the first spherical bodies 28 and 28 are pushed against the support body 3, and thus the movable body 4 can be caused to operate with respect to the support body 3 in the second pivoting direction with high accuracy, without causing rattling of the movable body 4 with respect to the first spherical bodies 28 and 28 in the axial direction of the first fulcrum axis Q1.

Furthermore, the movable body 4 is energized in the direction in which the movable body 4 is pushed against the second spherical body 33 in the axial direction of the second fulcrum axis Q2.

Thus, the movable body 4 is pushed against the second spherical body 33 and the second spherical body 33 is pushed against the support body 3, and thus the movable body 4 can be caused to operate with respect to the support body 3 in the first pivoting direction with high accuracy without causing rattling of the movable body 4 with respect to the first spherical bodies 28 and 28 in the axial direction of the second fulcrum axis Q2.

In addition, the first attracting magnets 26 and 26 and the second attracting magnets 31 and 31 are disposed on one of the support body 3 and the movable body 4 and the magnetic plates 45, 45, 47 and 47 are disposed on the other thereof, the magnetic plates 45 and 45, and 47 and 47 are attracted by the first attracting magnets 26 and 26, and the second attracting magnets 31 and 31, respectively and thus the movable body 4 is energized.

Thus, since the magnetic plates 45, 45, 47, and 47 disposed on the one of the support body 3 and the movable body 4 are attracted by the first attracting magnets 26 and 26 and the second attracting magnets 31 and 31 disposed on the other and thus the movable body 4 is energized, the movable body 4 can be reliably energized with the simple structure.

Furthermore, the second movability magnet 23 and the fourth movability magnet 25 provided in the second movability drive part 72 that causes the movable body 4 to operate with respect to the support body 3 are provided as the first attracting magnets 26 and 26.

Thus, since the second movability magnet 23 and the fourth movability magnet 25 that cause the movable body 4 to operate with respect to the support body 3 are used as the first attracting magnets 26 and 26 that energize the movable body 4, it is not necessary to provide the second movability magnet 23 and the fourth movability magnet 25 for drive and the first attracting magnet 26, 26 for attraction separately, and thus a reduction in the number of components and simplification of the structure can be achieved.

Furthermore, two movability drive parts including the first movability drive part 71 and the second movability drive part 72 are provided as drive parts positioned to be separated to the upper and lower sides or the left and right sides to cause the movable body 4 to operate with respect to the support body 3.

Thus, since the movable body 4 is moved in the optical axis direction and is pivoted in the first pivoting direction and the second pivoting direction with respect to the support body 3 due to the two movability drive parts, the number of movability drive parts is small, and thus the movable body 4 can be caused to operate with respect to the support body 3 in a simple structure.

In addition, the first movability magnet 22 and the first movability coil 40 are provided in the first movability drive part 71, the second movability magnet 23, the third movability magnet 24, and the fourth movability magnet 25, and the second movability coil 42, the third movability coil 43, and the fourth movability coil 44 are provided in the second movability drive part 72.

Thus, since the movable body 4 is moved in the optical axis direction and is pivoted in the first pivoting direction and the second pivoting direction with respect to the support body 3 by the two movability drive parts including the first movability drive part 71 in which one magnet and one coil are provided, the number of components of movability drive parts is small, and thus the movable body 4 can be caused operate with respect to the support body 3 in a simple structure.

In addition, the fixed body 2 that freely movably supports the support body 3 is provided, and the support body 3 is movable with respect to the fixed body 2 in the first movement direction (X direction) orthogonal to the optical axis P and the second movement direction (Y direction) orthogonal to the optical axis direction and the first movement direction.

Thus, the movable body 4 is operable with respect to the fixed body 2 in the first movement direction and the second movement direction in addition to the optical axis direction, the first pivoting direction, and the second pivoting direction, improvement in functionality of the optical device 1 can be achieved.

Furthermore, since an image sensor is provided as the optical element 50, the image sensor 50 is moved in the optical axis direction due to movement of the movable body 4 in the optical axis direction, flange focal distances can be easily adjusted.

Furthermore, the support body 3 is pivotable with respect to the fixed body 2 in the direction around the optical axis.

Thus, since the movable body 4 is operable with respect to the fixed body 2 in the direction around the optical axis in addition to the optical axis direction, the first pivoting direction, the second pivoting direction, the first movement direction, and the second movement direction, further improvement in the functionality of the optical device 1 can be achieved.

In addition, the second operation drive part 62, the third operation drive part 63, and the fourth operation drive part 64 are provided as operation drive parts that cause the support body 3 to operate with respect to the fixed body 2, the first operation drive part 61, and the direction in which the first operation drive part 61 and the second operation drive part 62 are connected is set to be the same as the direction in which the third operation drive part 63 and the fourth operation drive part 64 are connected.

Thus, since the positional relation between the first operation drive part 61 and the second operation drive part 62 is the same as the positional relation between the third operation drive part 63 and the fourth operation drive part 64 in the disposition direction, the four operation drive parts are well balanced in disposition, and thus stable operation states of the support body 3 with respect to the fixed body 2 can be ensured.

### <Present Technology>

The present technology can be configured as follows.

(1)

An optical device including:

a movable body including an optical element;

a support body configured to support the movable body;

at least one first spherical body configured to be positioned between the movable body and the support body in an axial direction of a first fulcrum axis orthogonal to an optical axis and to be rollable; and

at least one second spherical body configured to be positioned between the movable body and the support body in an axial direction of a second fulcrum axis orthogonal to the optical axis and the first fulcrum axis and to be rollable,

in which the movable body is supported by the support body via the first spherical body and the second spherical body, and

the movable body is movable in an optical axis direction and is pivotable in a first pivoting direction with the first fulcrum axis as a fulcrum and a second pivoting direction with the second fulcrum axis as a fulcrum with respect to the support body.

(2)

The optical device according to (1), in which a plurality of at least one of the first spherical bodies or the second spherical bodies is provided.

(3)

The optical device according to (1) or (2), in which the movable body is energized in a direction in which the movable body is pushed against the first spherical body in the axial direction of the first fulcrum axis.

(4)

The optical device according to any one of (1) to (3), in which the movable body is energized in a direction in which the movable body is pushed against the second spherical body in the axial direction of the second fulcrum axis.

(5)

The optical device according to any one of (1) to (4),

in which the movable body is energized in at least one direction of a direction in which the movable body is pushed against the first spherical body in the axial direction of the first fulcrum axis or a direction in which the movable body is pushed against the second spherical body in the axial direction of the second fulcrum axis,

a magnet is disposed on one of the support body and the movable body and a magnetic plate is disposed on the other of the support body and the movable body, and

the magnetic plate is attracted by the magnet and thus the movable body is energized.

(6)

The optical device according to (5), in which at least one of the first spherical body or the second spherical body is positioned in a row with the magnet in the axial direction of the first fulcrum axis or the axial direction of the second fulcrum axis.

(7)

The optical device according to (6),

in which a spherical body support member configured to freely rollably support each of the first spherical body and the second spherical body is provided,

a disposition base on which the magnet is disposed is provided, and

the spherical body support member is disposed on the disposition base.

(8)

The optical device according to any one of (5) to (7),

in which the magnet is provided in a movability drive part that causes the movable body to operate with respect to the support body.

(9)

The optical device according to any one of (1) to (8), in which two movability drive parts that are positioned to be separated to upper and lower sides or left and right sides and cause the movable body to operate with respect to the support body are provided.

(10)

The optical device according to (9),

in which one magnet and one coil are provided in one of the movability drive parts, and

a plurality of magnets and a plurality of coils are provided in the other of the movability drive parts.

(11)

The optical device according to any one of (1) to (10),

in which a frame part that is penetrated in the optical axis direction is provided in the movable body, and

the optical element is held by the frame part.

(12)

The optical device according to any one of (1) to (11), in which a frame-shaped part that is penetrated in the optical axis direction is provided in the support body.

(13)

The optical device according to (12), in which the movable body is positioned on an inner side of an inner circumference of the frame-shaped part.

(14)

The optical device according to any one of (1) to (13), in which an image sensor is provided as the optical element.

(15)

The optical device according to any one of (1) to (14),

in which a fixed body that freely movably supports the support body is provided, and

the support body is movable with respect to the fixed body in a first movement direction orthogonal to the optical axis and a second movement direction orthogonal to the optical axis direction and the first movement direction.

(16)

The optical device according to (15), in which the support body is pivotable with respect to the fixed body in a direction around the optical axis.

(17)

The optical device according to (16),

in which three operation drive parts that cause the support body to operate with respect to the fixed body are provided,

two operation drive parts among the three operation drive parts are disposed to be separated in the axial direction of the first fulcrum axis or the axial direction of the second fulcrum axis, and

the operation drive part other than the two operation drive parts among the three operation drive parts is disposed to be separated from the two operation drive parts in a direction orthogonal to a direction in which the two operation drive parts are connected.

(18)

The optical device according to (17),

in which a first operation drive part and a second operation drive part are provided as the two operation drive parts,

a third operation drive part is provided as the operation drive part other than the two operation drive parts,

a fourth operation drive part is provided as an operation drive part that causes the support body to operate with respect to the fixed body, and

the fourth operation drive part is disposed to be separated from the third operation drive part in a direction in which the first operation drive part and the second operation drive part are connected.

(19)

The optical device according to any one of (15) to (18), in which the support body is positioned on an inner side of an outer circumference of the fixed body.

(20)

An imaging device including

an optical device that causes an optical element to operate,

in which an imaging operation is performed by converting an optical image that has been taken in via an optical system into an electrical signal,

the optical device includes

a movable body including the optical element,

a support body configured to support the movable body,

at least one first spherical body configured to be positioned between the movable body and the support body in an axial direction of a first fulcrum axis orthogonal to an optical axis and to be rollable, and

at least one second spherical body configured to be positioned between the movable body and the support body in an axial direction of a second fulcrum axis orthogonal to the optical axis and the first fulcrum axis and to be rollable,

the movable body is supported by the support body via the first spherical body and the second spherical body, and

the movable body is movable in an optical axis direction and is pivotable in a first pivoting direction with the first fulcrum axis as a fulcrum and a second pivoting direction with the second fulcrum axis as a fulcrum with respect to the support body.

### REFERENCE SIGNS LIST

100 imaging device
1 optical device
2 fixed body
3 support body
4 movable body
6 first operation magnet
7 second operation magnet
8 third operation magnet
9 fourth operation magnet
14 frame-shaped part
19 first disposition base
20 second disposition base
21 third disposition base
22 first movability magnet
23 second movability magnet
24 third movability magnet
25 fourth movability magnet
26 first attracting magnet
27 first spherical body support member
28 first spherical body
31 second attracting magnet
32 second spherical body support member
33 second spherical body
36 frame part
40 first movability coil
42 second movability coil
43 third movability coil
44 fourth movability coil
45 magnetic plate
47 magnetic plate
50 optical element
61 first operation drive part
62 second operation drive part
63 third operation drive part
64 fourth operation drive part
71 first movability drive part
72 second movability drive part

1. An optical device comprising:
a movable body including an optical element;
a support body configured to support the movable body;
at least one first spherical body configured to be positioned between the movable body and the support body in an axial direction of a first fulcrum axis orthogonal to an optical axis and to be rollable; and
at least one second spherical body configured to be positioned between the movable body and the support body in an axial direction of a second fulcrum axis orthogonal to the optical axis and the first fulcrum axis and to be rollable,
wherein the movable body is supported by the support body via the first spherical body and the second spherical body, and
the movable body is movable in an optical axis direction and is pivotable in a first pivoting direction with the first fulcrum axis as a fulcrum and a second pivoting direction with the second fulcrum axis as a fulcrum with respect to the support body.

2. The optical device according to claim 1, wherein a plurality of at least one of the first spherical bodies or the second spherical bodies is provided.

3. The optical device according to claim 1, wherein the movable body is energized in a direction in which the movable body is pushed against the first spherical body in the axial direction of the first fulcrum axis.

4. The optical device according to claim 1, wherein the movable body is energized in a direction in which the movable body is pushed against the second spherical body in the axial direction of the second fulcrum axis.

5. The optical device according to claim 1,
wherein the movable body is energized in at least one direction of a direction in which the movable body is pushed against the first spherical body in the axial direction of the first fulcrum axis or a direction in which the movable body is pushed against the second spherical body in the axial direction of the second fulcrum axis,
a magnet is disposed on one of the support body and the movable body and a magnetic plate is disposed on the other of the support body and the movable body, and
the magnetic plate is attracted by the magnet and thus the movable body is energized.

6. The optical device according to claim 5, wherein at least one of the first spherical body or the second spherical body is positioned in a row with the magnet in the axial direction of the first fulcrum axis or the axial direction of the second fulcrum axis.

7. The optical device according to claim 6,
wherein a spherical body support member configured to freely rollably support each of the first spherical body and the second spherical body is provided,
a disposition base on which the magnet is disposed is provided, and
the spherical body support member is disposed on the disposition base.

8. The optical device according to claim 5,
wherein the magnet is provided in a movability drive part that causes the movable body to operate with respect to the support body.

9. The optical device according to claim 1, wherein two movability drive parts that are positioned to be separated to upper and lower sides or left and right sides and cause the movable body to operate with respect to the support body are provided.

10. The optical device according to claim 9,
wherein one magnet and one coil are provided in one of the movability drive parts, and
a plurality of magnets and a plurality of coils are provided in the other of the movability drive parts.

11. The optical device according to claim 1,
wherein a frame part that is penetrated in the optical axis direction is provided in the movable body, and
the optical element is held by the frame part.

12. The optical device according to claim 1, wherein a frame-shaped part that is penetrated in the optical axis direction is provided in the support body.

13. The optical device according to claim 12, wherein the movable body is positioned on an inner side of an inner circumference of the frame-shaped part.

14. The optical device according to claim 1, wherein an image sensor is provided as the optical element.

15. The optical device according to claim 1,
wherein a fixed body that freely movably supports the support body is provided, and
the support body is movable with respect to the fixed body in a first movement direction orthogonal to the optical axis and a second movement direction orthogonal to the optical axis direction and the first movement direction.

16. The optical device according to claim 15, wherein the support body is pivotable with respect to the fixed body in a direction around the optical axis.

17. The optical device according to claim 16,
wherein three operation drive parts that cause the support body to operate with respect to the fixed body are provided,
two operation drive parts among the three operation drive parts are disposed to be separated in the axial direction of the first fulcrum axis or the axial direction of the second fulcrum axis, and
the operation drive part other than the two operation drive parts among the three operation drive parts is disposed to be separated from the two operation drive parts in a direction orthogonal to a direction in which the two operation drive parts are connected.

18. The optical device according to claim 17,
wherein a first operation drive part and a second operation drive part are provided as the two operation drive parts,
a third operation drive part is provided as the operation drive part other than the two operation drive parts,
a fourth operation drive part is provided as an operation drive part that causes the support body to operate with respect to the fixed body, and
the fourth operation drive part is disposed to be separated from the third operation drive part in a direction in which the first operation drive part and the second operation drive part are connected.

19. The optical device according to claim 15, wherein the support body is positioned on an inner side of an outer circumference of the fixed body.

20. An imaging device comprising
an optical device that causes an optical element to operate,
wherein an imaging operation is performed by converting an optical image that has been taken in via an optical system into an electrical signal,
the optical device includes
a movable body including the optical element,
a support body configured to support the movable body,
at least one first spherical body configured to be positioned between the movable body and the support body in an axial direction of a first fulcrum axis orthogonal to an optical axis and to be rollable, and
at least one second spherical body configured to be positioned between the movable body and the support body in an axial direction of a second fulcrum axis orthogonal to the optical axis and the first fulcrum axis and to be rollable,
the movable body is supported by the support body via the first spherical body and the second spherical body, and
the movable body is movable in an optical axis direction and is pivotable in a first pivoting direction with the first fulcrum axis as a fulcrum and a second pivoting direction with the second fulcrum axis as a fulcrum with respect to the support body.
